(19) United States
(12) Patent Application Publication
(10) Pub. No.: US 2025/0189770 A1
(43) Pub. Date: Jun. 12, 2025

(54) ZOOM OPTICAL SYSTEM, OPTICAL APPARATUS AND METHOD FOR MANUFACTURING THE ZOOM OPTICAL SYSTEM

(71) Applicant: NIKON CORPORATION, Minato-ku, Tokyo (JP)

(72) Inventors: Tomoyuki SASHIMA, Tokyo (JP); Norikazu YOKOI, Kanagawa (JP); Takahiro ISHIKAWA, Kanagawa (JP)

(21) Appl. No.: 18/288,808

(22) PCT Filed: Mar. 4, 2022
(86) PCT No.: PCT/JP2022/009426

§ 371 Date: Jun. 17, 2024

(30) Foreign Application Priority Data
Jun. 15, 2021 (JP) 2021-099589

(51) Int. Cl. G02B 15/14; G02B 15/16

(52) U.S. Cl. CPC G02B 15/145105; G02B 15/16

(57) ABSTRACT

This variable-magnification optical system (ZL) comprises, in order along an optical axis from the object side, a first lens group (G1) that has a positive refractive power, a second lens group (G2) that has a negative refractive power, a third lens group (G3) that has a positive refractive power, a fourth lens group (G4) that has a negative refractive power, and a fifth lens group (G5) that has a negative refractive power. The distances between adjacent lens groups change during magnification. The fourth lens group (G4) is a focusing lens group that moves along the optical axis during focusing. The following conditional expression is satisfied: 0.11<f4/f5<0.70, where f4 is the focal length of the fourth lens group (G4) and f5 is the focal length of the fifth lens group (G5).

### TECHNICAL FIELD

The present invention relates to a zoom optical system, an optical apparatus, and a method for manufacturing the zoom optical system.

### TECHNICAL BACKGROUND

In related art, a zoom optical system has been suggested which is suitable for a photographic camera, an electronic still camera, a video camera, or the like (for example, see Patent Literature 1). In such a zoom optical system, it is difficult to obtain excellent optical performance while realizing size reduction and weight reduction.

### PRIOR ARTS LIST

### Patent Document

Patent literature 1: Japanese Laid-Open Patent Publication No. 2014-228808(A)

### SUMMARY OF THE INVENTION

A zoom optical system according to a first aspect of the present invention comprises: a first lens group having positive refractive power; a second lens group having negative refractive power; a third lens group having positive refractive power; a fourth lens group having negative refractive power; and a fifth lens group having negative refractive power, the first, second, third, fourth, and fifth lens groups being aligned in order from an object side along an optical axis, in which when zooming is performed, intervals between neighboring lens groups are changed, the fourth lens group is a focusing lens group which moves along the optical axis when focusing is performed, and the following conditional expression is satisfied,

$$0.11 < f 4 / f 5 < 0.7$$

where f4 denotes a focal length of the fourth lens group, and

f5 denotes a focal length of the fifth lens group.

A zoom optical system according to a second aspect of the present invention consists of: a first lens group having positive refractive power; a second lens group having negative refractive power; an intermediate group which has at least one lens group and which has positive refractive power; a focusing lens group having negative refractive power; and a rear group having at least one lens group, the first lens group, the second lens group, the intermediate group, the focusing lens group, and the rear group being aligned in order from an object side along an optical axis, in which when zooming is performed, intervals between neighboring lens groups are changed, the focusing lens group moves along the optical axis when focusing is performed, and the following conditional expressions are satisfied,

$$\begin{matrix}0.3 < ( - f 2 ) / fMt < 0.8 \\ 0.01 < Bfw / fw < 0.95\end{matrix}$$

where f2 denotes a focal length of the second lens group,

fMt denotes a focal length of the intermediate group in a telephoto end state,

Bfw denotes a back focal length of the zoom optical system in a wide angle end state, and

fw denotes a focal length of the zoom optical system in the wide angle end state.

An optical apparatus according to the present invention includes the zoom optical system.

In a method for manufacturing a zoom optical system according to the present invention, the zoom optical system comprises a first lens group having positive refractive power; a second lens group having negative refractive power, a third lens group having positive refractive power; a fourth lens group having negative refractive power; and a fifth lens group having negative refractive power, which are aligned in order from an object side along an optical axis. The method comprises a step of arranging the lens groups in a lens barrel so that:

when zooming is performed, intervals between neighboring lens groups are changed,

the fourth lens group is a focusing lens group which moves along the optical axis when focusing is performed, and

the following conditional expression is satisfied,

$$0.11 < f 4 / f 5 < 0.7$$

where f4 denotes a focal length of the fourth lens group, and

f5 denotes a focal length of the fifth lens group.

### BRIEF DESCRIPTION OF THE DRAWINGS

FIG. 1 is a diagram illustrating a lens configuration of a zoom optical system according to a first example;

FIG. 2A and FIG. 2B are diagrams of various aberrations of the zoom optical system according to the first example upon focusing on infinity respectively in a wide angle end state and a telephoto end state;

FIG. 3 is a diagram illustrating a lens configuration of a zoom optical system according to a second example;

FIG. 4A and FIG. 4B are diagrams of various aberrations of the zoom optical system according to the second example upon focusing on infinity respectively in the wide angle end state and the telephoto end state;

FIG. 5 is a diagram illustrating a lens configuration of a zoom optical system according to a third example;

FIG. 6A and FIG. 6B are diagrams of various aberrations of the zoom optical system according to the third example upon focusing on infinity respectively in the wide angle end state and the telephoto end state;

FIG. 7 is a diagram illustrating a lens configuration of a zoom optical system according to a fourth example;

FIG. 8A and FIG. 8B are diagrams of various aberrations of the zoom optical system according to the fourth example upon focusing on infinity respectively in the wide angle end state and the telephoto end state;

FIG. 9 is a diagram illustrating a configuration of a camera which includes a zoom optical system according to each embodiment;

FIG. 10 is a flowchart illustrating a method for manufacturing a zoom optical system according to a first embodiment; and

FIG. 11 is a flowchart illustrating a method for manufacturing a zoom optical system according to a second embodiment.

### DESCRIPTION OF THE EMBODIMENTS

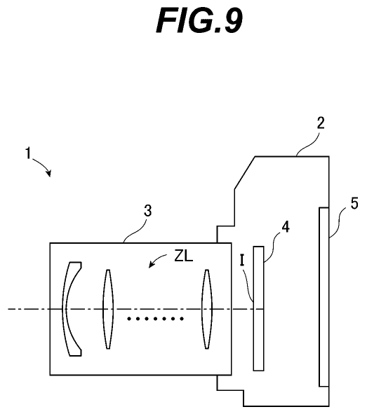

Preferable embodiments according to the present invention will hereinafter be described. First, a description will be made, based on FIG. 9, about a camera (optical apparatus) including a zoom optical system according to each of the embodiments. As illustrated in FIG. 9, this camera 1 includes a main body 2 and a photographing lens 3 to be mounted on the main body 2. The main body 2 includes an image-capturing element 4, a main-body control part (not illustrated) which controls actions of a digital camera, and a liquid crystal screen 5. The photographing lens 3 includes a zoom optical system ZL which is formed with a plurality of lens groups and a lens position control mechanism (not illustrated) which controls a position of each of the lens groups. The lens position control mechanism includes a sensor which detects the position of the lens group, a motor which moves the lens group forward and rearward along an optical axis, a control circuit which drives the motor, and so forth.

Light from a photographed object is collected by the zoom optical system ZL of the photographing lens 3 and reaches an image surface I of the image-capturing element 4. Light from the photographed object which reaches the image surface I is subjected to photoelectric conversion by the image-capturing element 4, and is recorded as digital image data in a memory which is not illustrated. The digital image data recorded in the memory are capable of being displayed on the liquid crystal screen 5 in accordance with an operation by a user. Note that this camera may be a mirrorless camera or a single-lens reflex camera having an instant return mirror. Further, the zoom optical system ZL illustrated in FIG. 9 schematically illustrates the zoom optical system which is included in the photographing lens 3, but a lens configuration of the zoom optical system ZL is not limited to this configuration.

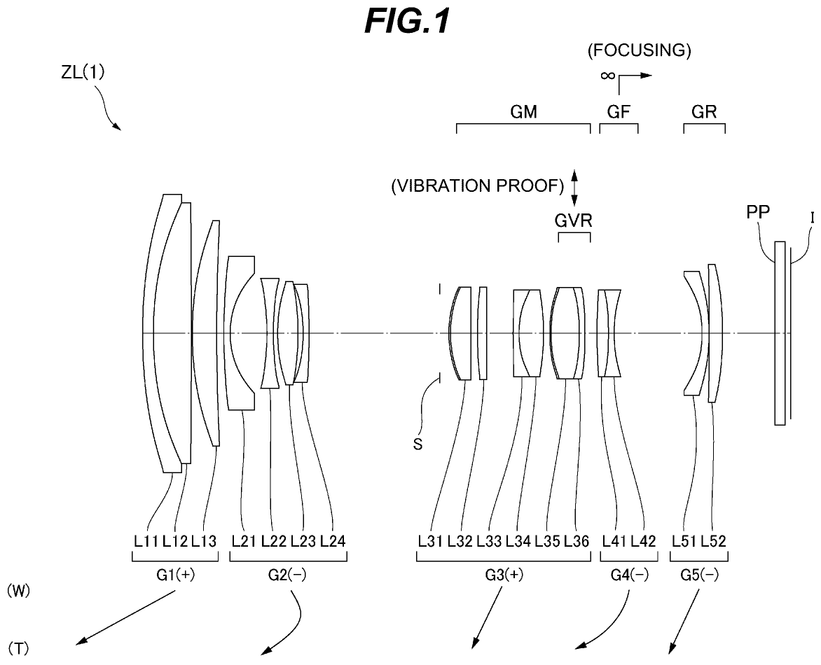

Next, a zoom optical system according to a first embodiment will be described. As illustrated in FIG. 1, a zoom optical system ZL(1) as one example of the zoom optical system (zoom lens) ZL according to the first embodiment is configured to have a first lens group G1 having positive refractive power, a second lens group G2 having negative refractive power, a third lens group G3 having positive refractive power, a fourth lens group G4 having negative refractive power, and a fifth lens group G5 having negative refractive power, which are aligned in order from an object side along an optical axis. When zooming is performed, intervals between neighboring lens groups are changed. The fourth lens group G4 is a focusing lens group GF which moves along the optical axis when focusing is performed.

In the above configuration, the zoom optical system ZL according to the first embodiment satisfies the following conditional expression (1).

$$0.11 < f 4 / f 5 < 0.7 \qquad ( 1 )$$

Where f4 denotes a focal length of the fourth lens group G4, and

f5 denotes a focal length of the fifth lens group G5.

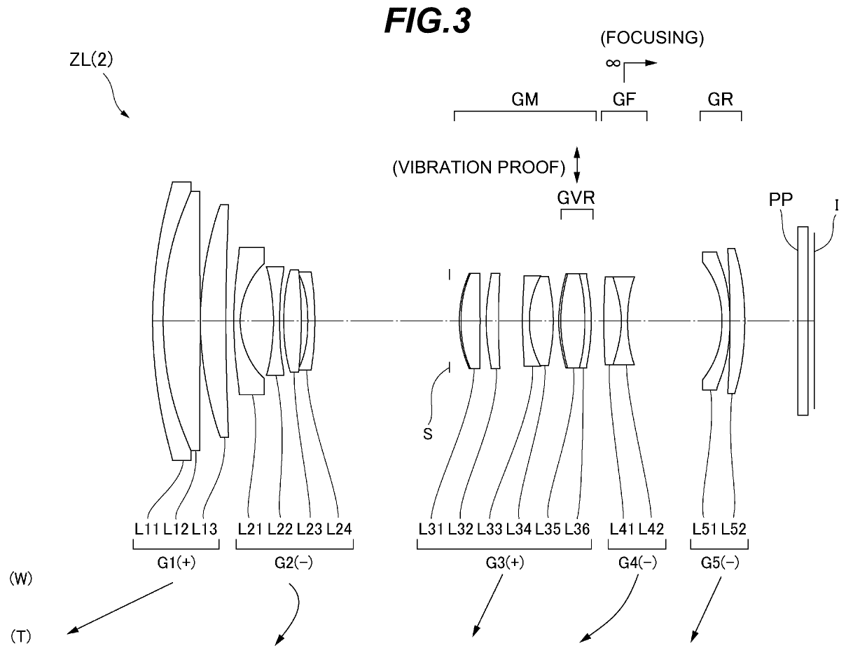

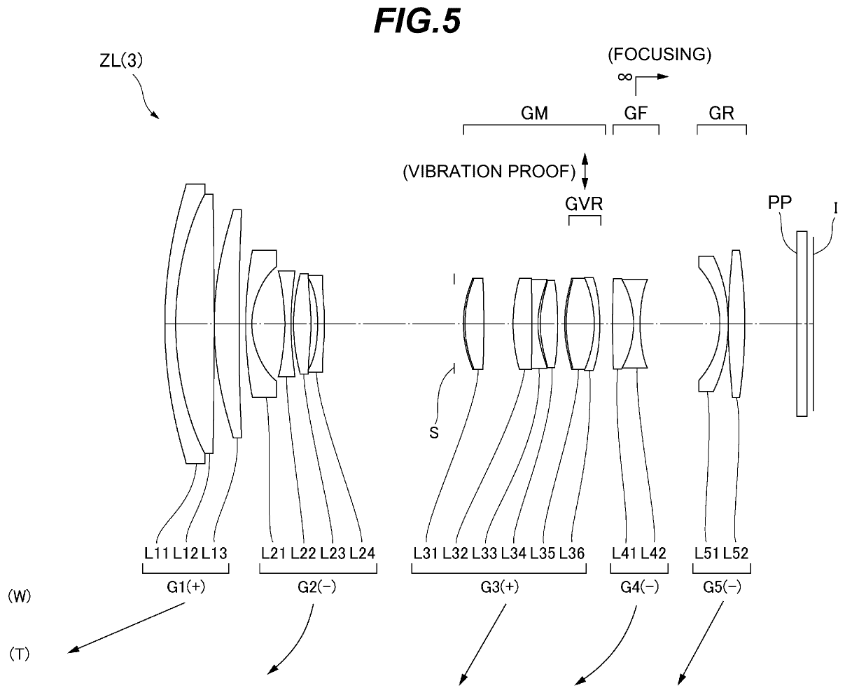

In the first embodiment, it becomes possible to obtain a zoom optical system which provides excellent optical performance while realizing size reduction and weight reduction and to obtain an optical apparatus which includes the zoom optical system. The zoom optical system ZL according to the first embodiment may be a zoom optical system ZL(2) illustrated in FIG. 3 or may be a zoom optical system ZL(3) illustrated in FIG. 5.

The conditional expression (1) defines an appropriate relationship between the focal length of the fourth lens group G4 and the focal length of the fifth lens group G5. By satisfying the conditional expression (1), a spherical aberration, a coma aberration, and field curves can properly be corrected.

When a corresponding value of the conditional expression (1) exceeds an upper limit value, the focal length of the fourth lens group G4 becomes long, a movement amount of the fourth lens group G4 as the focusing lens group in focusing thereby becomes large, and it becomes difficult to suppress fluctuations in the spherical aberration, the coma aberration, and the field curves when focusing is performed. Further, the focal length of the fifth lens group G5 becomes short, and it thereby becomes difficult to correct the field curves which occur in the fifth lens group G5. The upper limit value of the conditional expression (1) is set to 0.65 or further 0.60, and effects of the present embodiment can thereby more certainly be obtained.

When the corresponding value of the conditional expression (1) falls below a lower limit value, the focal length of the fourth lens group G4 becomes short, and it thereby becomes difficult to correct the spherical aberration, the coma aberration, and the field curves which occur in the fourth lens group G4. Further, the focal length of the fifth lens group G5 becomes long, correction effect for the field curves by the fifth lens group G5 thereby become low, and it becomes difficult to obtain excellent optical performance. The lower limit value of the conditional expression (1) is set to 0.15 or further 0.20, and the effects of the present embodiment can thereby more certainly be obtained.

It is desirable that the zoom optical system ZL according to the first embodiment satisfy the following conditional expression (2).

$$0.01 < ( - f 4 ) / f 3 < 5. \qquad ( 2 )$$

Where f3 denotes a focal length of the third lens group G3.

The conditional expression (2) defines an appropriate relationship between the focal length of the fourth lens group G4 and the focal length of the third lens group G3. By satisfying the conditional expression (2), the spherical aberration, the coma aberration, and the field curves can properly be corrected.

When a corresponding value of the conditional expression (2) exceeds an upper limit value, the focal length of the fourth lens group G4 becomes long, the movement amount of the fourth lens group G4 as the focusing lens group in focusing thereby becomes large, and it becomes difficult to suppress fluctuations in the spherical aberration, the coma aberration, and the field curves when focusing is performed. Further, the focal length of the third lens group G3 becomes short, and it thereby becomes difficult to correct the spherical aberration and the coma aberration which occur in the third lens group G3. The upper limit value of the conditional expression (2) is set to 4.50, 4.20, 3.90, 3.50, 3.00, 2.75, 2.50, or further 2.30, and the effects of the present embodiment can thereby more certainly be obtained.

When the corresponding value of the conditional expression (2) falls below a lower limit value, the focal length of the fourth lens group G4 becomes short, and it thereby becomes difficult to correct the spherical aberration, the coma aberration, and the field curves which occur in the fourth lens group G4. Further, the focal length of the third lens group G3 becomes long, a movement amount of the third lens group G3 in zooming thereby becomes large, and it becomes difficult to suppress fluctuations in the spherical aberration and the coma aberration when zooming is performed. The lower limit value of the conditional expression (2) is set to 0.05, 1.00, 1.25, or further 1.50, and the effects of the present embodiment can thereby more certainly be obtained.

It is desirable that the zoom optical system ZL according to the first embodiment satisfy the following conditional expression (3).

$$0.01 < f 3 / ( - f 5 ) < 1. \qquad ( 3 )$$

Where f3 denotes the focal length of the third lens group G3.

The conditional expression (3) defines an appropriate relationship between the focal length of the third lens group G3 and the focal length of the fifth lens group G5. By satisfying the conditional expression (3), the spherical aberration, the coma aberration, and the field curves can properly be corrected.

When a corresponding value of the conditional expression (3) exceeds an upper limit value, the focal length of the third lens group G3 becomes long, the movement amount of the third lens group G3 in zooming thereby becomes large, and it becomes difficult to suppress fluctuations in the spherical aberration and the coma aberration when zooming is performed. Further, the focal length of the fifth lens group G5 becomes short, and it thereby becomes difficult to correct the field curves which occur in the fifth lens group G5. The upper limit value of the conditional expression (3) is set to 0.75, 0.50, 0.29, or further 0.25, and the effects of the present embodiment can thereby more certainly be obtained.

When the corresponding value of the conditional expression (3) falls below a lower limit value, the focal length of the third lens group G3 becomes short, and it thereby becomes difficult to correct the spherical aberration and the coma aberration which occur in the third lens group G3. Further, the focal length of the fifth lens group G5 becomes long, the correction effect for the field curves by the fifth lens group G5 thereby become low, and it becomes difficult to obtain excellent optical performance. The lower limit value of the conditional expression (3) is set to 0.05 or further 0.09, and the effects of the present embodiment can thereby more certainly be obtained.

It is desirable that the zoom optical system ZL according to the first embodiment satisfy the following conditional expression (4).

$$0.01 < f 3 / ( - f 45 t ) < 2. \qquad ( 4 )$$

Where f3 denotes the focal length of the third lens group G3, and

f45t denotes a combined focal length of the fourth lens group G4 and the fifth lens group G5 in the telephoto end state.

The conditional expression (4) defines an appropriate relationship between the focal length of the third lens group G3 and the combined focal length of the fourth lens group G4 and the fifth lens group G5 in the telephoto end state. By satisfying the conditional expression (4), the spherical aberration, the coma aberration, and the field curves can properly be corrected.

When a corresponding value of the conditional expression (4) exceeds an upper limit value, the focal length of the third lens group G3 becomes long, the movement amount of the third lens group G3 in zooming thereby becomes large, and it becomes difficult to suppress fluctuations in the spherical aberration and the coma aberration when zooming is performed. Further, the combined focal length of the fourth lens group G4 and the fifth lens group G5 in the telephoto end state becomes short, and it thereby becomes difficult to correct the spherical aberration, the coma aberration, and the field curves which occur in the fourth lens group G4 and the fifth lens group G5. The upper limit value of the conditional expression (4) is set to 1.75, 1.50, 1.25, 0.90, or further 0.76, and the effects of the present embodiment can thereby more certainly be obtained.

When the corresponding value of the conditional expression (4) falls below a lower limit value, the focal length of the third lens group G3 becomes short, and it thereby becomes difficult to correct the spherical aberration and the coma aberration which occur in the third lens group G3. Further, the combined focal length of the fourth lens group G4 and the fifth lens group G5 in the telephoto end state becomes long, movement amounts of the fourth lens group G4 and the fifth lens group G5 in zooming thereby become large, and it becomes difficult to suppress fluctuations in the spherical aberration, the coma aberration, and the field curves when zooming is performed. The lower limit value of the conditional expression (4) is set to 0.10, 0.25, 0.33, 0.45, or further 0.56, and the effects of the present embodiment can thereby more certainly be obtained.

It is desirable that the zoom optical system ZL according to the first embodiment satisfy the following conditional expression (5).

$$0.01 < β5 t / β5 w < 2. \qquad ( 5 )$$

Where β5t denotes a lateral magnification of the fifth lens group G5 in the telephoto end state.

β5w denotes the lateral magnification of the fifth lens group G5 in the wide angle end state.

The conditional expression (5) defines an appropriate relationship between the lateral magnification of the fifth lens group G5 in the telephoto end state and the lateral magnification of the fifth lens group G5 in the wide angle end state. It is preferable that the conditional expression (5) is satisfied, by which a zoom optical system, which provides excellent optical performance while realizing size reduction and weight reduction, can be obtained. An upper limit value of the conditional expression (5) is set to 1.80, 1.65, 1.55, 1.49, or further 1.30, and the effects of the present embodiment can thereby more certainly be obtained. A lower limit value of the conditional expression (5) is set to 0.10, 0.25, 0.50, 0.75, 0.90, or further 1.07, and the effects of the present embodiment can thereby more certainly be obtained.

It is desirable that the zoom optical system ZL according to the first embodiment satisfy the following conditional expression (6).

$$0.01 < Bfw / fw < 0.95 \qquad ( 6 )$$

Where Bfw denotes a back focal length of the zoom optical system ZL in the wide angle end state, and

fw denotes a focal length of the zoom optical system ZL in the wide angle end state.

The conditional expression (6) defines an appropriate relationship between the back focal length of the zoom optical system ZL in the wide angle end state and the focal length of the zoom optical system ZL in the wide angle end state. Note that in each of the embodiments, it is assumed that the back focal length of the zoom optical system ZL is an air equivalent distance on the optical axis from a lens surface on a side of the zoom optical system ZL, the side being closest to the image surface, to the image surface I. It is preferable that the conditional expression (6) is satisfied, by which a zoom optical system, which provides excellent optical performance while realizing size reduction and weight reduction, can be obtained. An upper limit value of the conditional expression (6) is set to 0.90, 0.85, 0.80, 0.78, 0.75, 0.65, or further 0.58, and the effects of the present embodiment can thereby more certainly be obtained. A lower limit value of the conditional expression (6) is set to 0.10, 0.30, 0.40, or further 0.50, and the effects of the present embodiment can thereby more certainly be obtained.

In the zoom optical system ZL according to the first embodiment, it is desirable that the fifth lens group G5 consist of two lenses. Accordingly, fluctuations in the field curves when zooming is performed can properly be suppressed.

In the zoom optical system ZL according to the first embodiment, it is desirable that the third lens group G3 have a lens which satisfies the following conditional expression (7).

$$75. < v 3 L \qquad ( 7 )$$

Where ν3L denotes an Abbe number of the lens in the third lens group G3.

The conditional expression (7) defines an appropriate range of the Abbe number of the lens in the third lens group G3. Because when the third lens group G3 has the lens which satisfies the conditional expression (7), a zoom optical system can be obtained in which a chromatic aberration is corrected and which provides excellent optical performance, such a zoom optical system is preferable. A lower limit value of the conditional expression (7) is set to 77.00, 80.00, or further 82.00, and the effects of the present embodiment can thereby more certainly be obtained.

In the zoom optical system ZL according to the first embodiment, it is desirable that the third lens group G3 have, in a part of the third lens group G3, a vibration proof group GVR which is movable to have a displacement component in a direction perpendicular to the optical axis. Accordingly, because a zoom optical system can be obtained which provides proper vibration proof performance while realizing size reduction and weight reduction, such a zoom optical system is preferable.

It is desirable that the zoom optical system ZL according to the first embodiment satisfy the following conditional expression (8).

$$0.01 < f 3 / fVR < 2. \qquad ( 8 )$$

Where f3 denotes the focal length of the third lens group G3, and

fVR denotes a focal length of the vibration proof group GVR.

The conditional expression (8) defines an appropriate relationship between the focal length of the third lens group G3 and the focal length of the vibration proof group GVR. By satisfying the conditional expression (8), an eccentric coma aberration and asymmetrical field curves in a case where image blur is corrected are thereby suppressed, and proper vibration proof performance can be obtained.

When a corresponding value of the conditional expression (8) exceeds an upper limit value, the focal length of the vibration proof group GVR becomes short, and it thereby becomes difficult to suppress the eccentric coma aberration and the asymmetrical field curves which occur in the vibration proof group GVR in a case where the image blur is corrected. The upper limit value of the conditional expression (8) is set to 1.75, 1.50, 1.25, or further 1.00, and the effects of the present embodiment can thereby more certainly be obtained.

When the corresponding value of the conditional expression (8) falls below a lower limit value, the focal length of the vibration proof group GVR becomes long, a movement amount of the vibration proof group GVR in a case where the image blur is corrected thereby becomes large, and it becomes difficult to suppress the eccentric coma aberration and the asymmetrical field curves. The lower limit value of the conditional expression (8) is set to 0.10, 0.30, 0.40, or further 0.45, and the effects of the present embodiment can thereby more certainly be obtained.

In the zoom optical system ZL according to the first embodiment, it is desirable that the vibration proof group GVR be arranged on a side of the third lens group G3, the side being closest to the image surface. Accordingly, proper vibration proof performance can be obtained while the optical performance as the zoom optical system is maintained.

Next, a zoom optical system according to a second embodiment will be described. As illustrated in FIG. 1, the zoom optical system ZL(1) as one example of the zoom optical system (zoom lens) ZL according to the second embodiment consists of the first lens group G1 having positive refractive power, the second lens group G2 having negative refractive power, an intermediate group GM which has at least one lens group and which has positive refractive power, a focusing lens group GF having negative refractive power, and a rear group GR having at least one lens group, which are aligned in order from the object side along the optical axis. When zooming is performed, intervals between neighboring lens groups are changed. The focusing lens group GF moves along the optical axis when focusing is performed.

In the above configuration, the zoom optical system ZL according to the second embodiment satisfies the following conditional expression (9) and the above-described conditional expression (6).

$$0.3 < ( - f 2 ) / dMt < 0.8 \qquad ( 9 )$$

$$0.01 < Bfw / fw < 0.95 \qquad ( 6 )$$

Where f2 denotes a focal length of the second lens group G2,

fMt denotes a focal length of the intermediate group GM in the telephoto end state,

Bfw denotes the back focal length of the zoom optical system ZL in the wide angle end state, and

fw denotes the focal length of the zoom optical system ZL in the wide angle end state.

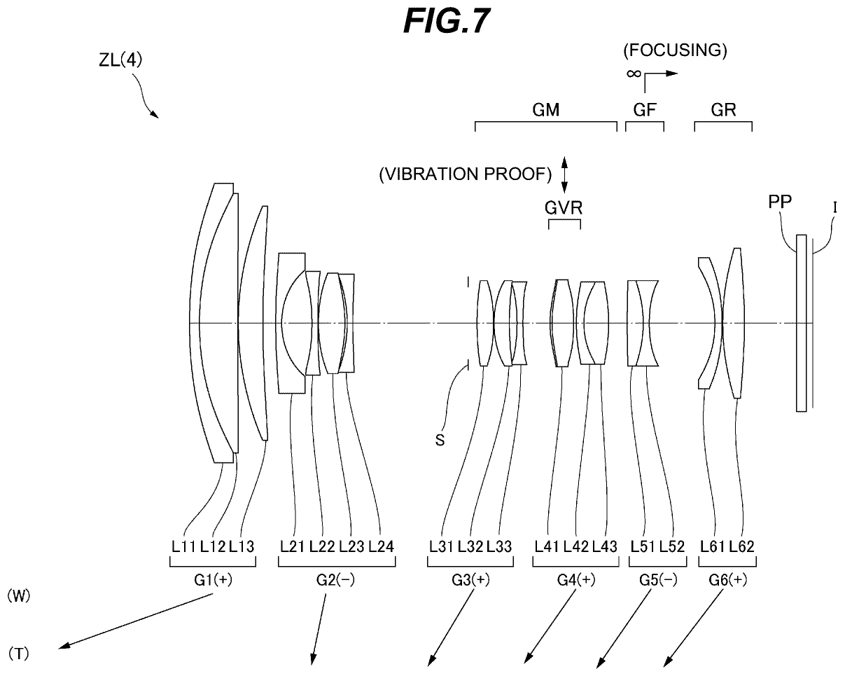

In the second embodiment, it becomes possible to obtain a zoom optical system which provides excellent optical performance while realizing size reduction and weight reduction and to obtain an optical apparatus which includes the zoom optical system. The zoom optical system ZL according to the second embodiment may be the zoom optical system ZL(2) illustrated in FIG. 3, may be the zoom optical system ZL(3) illustrated in FIG. 5, or a zoom optical system ZL(4) illustrated in FIG. 7.

The conditional expression (9) defines an appropriate relationship between the focal length of the second lens group G2 and the focal length of the intermediate group GM in the telephoto end state. By satisfying the conditional expression (9), the spherical aberration, the coma aberration, the field curves, and so forth can properly be corrected.

When a corresponding value of the conditional expression (9) exceeds an upper limit value, the focal length of the second lens group G2 becomes long, a movement amount of the second lens group G2 in zooming thereby becomes large, and it becomes difficult to suppress fluctuations in the spherical aberration, the coma aberration, and the field curves when zooming is performed. Further, the focal length of the intermediate group GM in the telephoto end state becomes short, and it thereby becomes difficult to correct the spherical aberration and the coma aberration which occur in the intermediate group GM. The upper limit value of the conditional expression (9) is set to 0.75 or further 0.70, and effects of the present embodiment can thereby more certainly be obtained.

When the corresponding value of the conditional expression (9) falls below a lower limit value, the focal length of the second lens group G2 becomes short, and it thereby becomes difficult to correct the spherical aberration, the coma aberration, and the field curves which occur in the second lens group G2. Further, the focal length of the intermediate group GM in the telephoto end state becomes long, a movement amount of the intermediate group GM in zooming thereby becomes large, and it becomes difficult to suppress fluctuations in the spherical aberration and the coma aberration when zooming is performed. The lower limit value of the conditional expression (9) is set to 0.40 or further 0.50, and the effects of the present embodiment can thereby more certainly be obtained.

As described above, the conditional expression (6) defines an appropriate relationship between the back focal length of the zoom optical system ZL in the wide angle end state and the focal length of the zoom optical system ZL in the wide angle end state. It is preferable that the conditional expression (6) is satisfied, by which a zoom optical system, which provides excellent optical performance while realizing size reduction and weight reduction, can be obtained. The upper limit value of the conditional expression (6) is set to 0.90, 0.85, 0.80, 0.78, 0.75, 0.65, or further 0.58, and the effects of the present embodiment can thereby more certainly be obtained. The lower limit value of the conditional expression (6) is set to 0.10, 0.30, 0.40, or further 0.50, and the effects of the present embodiment can thereby more certainly be obtained.

It is desirable that the zoom optical system ZL according to the second embodiment satisfy the following conditional expression (10).

$$0.01 < ( - fF ) / fMt < 5. \qquad ( 10 )$$

Where fF denotes a focal length of the focusing lens group GF.

The conditional expression (10) defines an appropriate relationship between the focal length of the focusing lens group GF and the focal length of the intermediate group GM in the telephoto end state. By satisfying the conditional expression (10), the spherical aberration, the coma aberration, and the field curves can properly be corrected.

When a corresponding value of the conditional expression (10) exceeds an upper limit value, the focal length of the focusing lens group GF becomes long, a movement amount of the focusing lens group GF in focusing thereby becomes large, and it becomes difficult to suppress fluctuations in the spherical aberration, the coma aberration, and the field curves when focusing is performed. Further, the focal length of the intermediate group GM in the telephoto end state becomes short, and it thereby becomes difficult to correct the spherical aberration and the coma aberration which occur in the intermediate group GM. The upper limit value of the conditional expression (10) is set to 4.50, 4.00, 3.50, 3.00, or further 2.30, and the effects of the present embodiment can thereby more certainly be obtained.

When the corresponding value of the conditional expression (10) falls below a lower limit value, the focal length of the focusing lens group GF becomes short, and it thereby becomes difficult to correct the spherical aberration, the coma aberration, and the field curves which occur in the focusing lens group GF. Further, the focal length of the intermediate group GM in the telephoto end state becomes long, the movement amount of the intermediate group GM in zooming thereby becomes large, and it becomes difficult to suppress fluctuations in the spherical aberration and the coma aberration when zooming is performed. The lower limit value of the conditional expression (10) is set to 0.10, 0.50, 0.70, 1.00, 1.25, or further 1.50, and the effects of the present embodiment can thereby more certainly be obtained.

It is desirable that the zoom optical system ZL according to the second embodiment satisfy the following conditional expression (11).

$$0.01 < fMt / \vert fRt \vert < 1. \qquad ( 11 )$$

Where fRt denotes a focal length of the rear group GR in the telephoto end state.

The conditional expression (11) defines an appropriate relationship between the focal length of the intermediate group GM in the telephoto end state and the focal length of the rear group GR in the telephoto end state. By satisfying the conditional expression (11), the spherical aberration, the coma aberration, and the field curves can properly be corrected.

When a corresponding value of the conditional expression (11) exceeds an upper limit value, the focal length of the intermediate group GM in the telephoto end state becomes long, the movement amount of the intermediate group GM in zooming thereby becomes large, and it becomes difficult to suppress fluctuations in the spherical aberration and the coma aberration when zooming is performed. Further, the focal length of the rear group GR in the telephoto end state becomes short, and it thereby becomes difficult to correct the field curves which occur in the rear group GR. The upper limit value of the conditional expression (11) is set to 0.85, 0.70, 0.60, 0.50, 0.35, or further 0.25, and the effects of the present embodiment can thereby more certainly be obtained.

When the corresponding value of the conditional expression (11) falls below a lower limit value, the focal length of the intermediate group GM in the telephoto end state becomes short, and it thereby becomes difficult to correct the spherical aberration and the coma aberration which occur in the intermediate group GM. Further, the focal length of the rear group GR in the telephoto end state becomes long, the correction effect for the field curves by the rear group GR thereby become low, and it becomes difficult to obtain excellent optical performance. The lower limit value of the conditional expression (11) is set to 0.03 or further 0.04, and the effects of the present embodiment can thereby more certainly be obtained.

It is desirable that the zoom optical system ZL according to the second embodiment satisfy the following conditional expression (12).

$$0.01 < ( - fF ) / \vert fRt \vert < 1. \qquad ( 12 )$$

Where fF denotes the focal length of the focusing lens group GF, and

fRt denotes the focal length of the rear group GR in the telephoto end state.

The conditional expression (12) defines an appropriate relationship between the focal length of the focusing lens group GF and the focal length of the rear group GR in the telephoto end state. By satisfying the conditional expression (12), the spherical aberration, the coma aberration, and the field curves can properly be corrected.

When a corresponding value of the conditional expression (12) exceeds an upper limit value, the focal length of the focusing lens group GF becomes long, the movement amount of the focusing lens group GF in focusing thereby becomes large, and it becomes difficult to suppress fluctuations in the spherical aberration, the coma aberration, and the field curves when focusing is performed. Further, the focal length of the rear group GR in the telephoto end state becomes short, and it thereby becomes difficult to correct the field curves which occur in the rear group GR. The upper limit value of the conditional expression (12) is set to 0.85, 0.75, 0.65, 0.60, or further 0.55, and the effects of the present embodiment can thereby more certainly be obtained.

When the corresponding value of the conditional expression (12) falls below a lower limit value, the focal length of the focusing lens group GF becomes short, and it thereby becomes difficult to correct the spherical aberration, the coma aberration, and the field curves which occur in the focusing lens group GF. Further, the focal length of the rear group GR in the telephoto end state becomes long, the correction effect for the field curves by the rear group GR thereby become low, and it becomes difficult to obtain excellent optical performance. The lower limit value of the conditional expression (12) is set to 0.06 or further 0.075, and the effects of the present embodiment can thereby more certainly be obtained.

It is desirable that the zoom optical system ZL according to the second embodiment satisfy the following conditional expression (13).

$$0.01 < fMt / ( - fFRt ) < 1. \qquad ( 13 )$$

Where fFRt denotes a combined focal length of the focusing lens group GF in the telephoto end state and at least one lens group of the rear group GR.

The conditional expression (13) defines an appropriate relationship between the focal length of the intermediate group GM in the telephoto end state and the combined focal length of the focusing lens group GF in the telephoto end state and at least one lens group of the rear group GR. By satisfying the conditional expression (13), the spherical aberration, the coma aberration, and the field curves can properly be corrected.

When a corresponding value of the conditional expression (13) exceeds an upper limit value, the focal length of the intermediate group GM in the telephoto end state becomes long, the movement amount of the intermediate group GM in zooming thereby becomes large, and it becomes difficult to suppress fluctuations in the spherical aberration and the coma aberration when zooming is performed. Further, the combined focal length of the focusing lens group GF in the telephoto end state and at least one lens group of the rear group GR becomes short, and it thereby becomes difficult to correct the spherical aberration, the coma aberration, and the field curves which occur in a lens group arranged on the image surface side relative to the intermediate group GM. The upper limit value of the conditional expression (13) is set to 0.90 or further 0.80, and the effects of the present embodiment can thereby more certainly be obtained.

When the corresponding value of the conditional expression (13) falls below a lower limit value, the focal length of the intermediate group GM in the telephoto end state becomes short, and it thereby becomes difficult to correct the spherical aberration and the coma aberration which occur in the intermediate group GM. Further, the combined focal length of the focusing lens group GF in the telephoto end state and at least one lens group of the rear group GR becomes long, a movement amount, in zooming, of the lens group arranged on the image surface side relative to the intermediate group GM becomes large, and it thereby becomes difficult to suppress fluctuations in the spherical aberration, the coma aberration, the field curves when zooming is performed. The lower limit value of the conditional expression (13) is set to 0.10, 0.25, 0.35, or further 0.45, and the effects of the present embodiment can thereby more certainly be obtained.

It is desirable that the zoom optical system ZL according to the second embodiment satisfy the following conditional expression (14).

$$0.1 < β Rt / β Rw < 2. \qquad ( 14 )$$

Where βRt denotes a lateral magnification of the rear group GR in the telephoto end state, and

βRw denotes a lateral magnification of the rear group GR in the wide angle end state.

The conditional expression (14) defines an appropriate relationship between the lateral magnification of the rear group GR in the telephoto end state and the lateral magnification of the rear group GR in the wide angle end state. It is preferable that the conditional expression (14) is satisfied, by which a zoom optical system, which provides excellent optical performance while realizing size reduction and weight reduction, can be obtained. An upper limit value of the conditional expression (14) is set to 1.80, 1.65, 1.50, 1.45, 1.35, or further 1.25, and the effects of the present embodiment can thereby more certainly be obtained. A lower limit value of the conditional expression (14) is set to 0.10, 0.25, 0.40, 0.50, or further 0.70, and the effects of the present embodiment can thereby more certainly be obtained.

In the zoom optical system ZL according to the second embodiment, it is desirable that the rear group GR consist of two lenses. Accordingly, fluctuations in the field curves when zooming is performed can properly be suppressed.

In the zoom optical system ZL according to the second embodiment, it is desirable that the intermediate group GM consist of one lens group. Accordingly, because a zoom optical system can be obtained which provides excellent optical performance while realizing size reduction and weight reduction, such a zoom optical system is preferable.

In the zoom optical system ZL according to the second embodiment, it is desirable that the rear group GR consist of one lens group. Accordingly, because a zoom optical system can be obtained which provides excellent optical performance while realizing size reduction and weight reduction, such a zoom optical system is preferable.

In the zoom optical system ZL according to the second embodiment, it is desirable that the rear group GR have negative refractive power. Accordingly, because a zoom optical system can be obtained which provides excellent optical performance while realizing size reduction and weight reduction, such a zoom optical system is preferable.

In the zoom optical system ZL according to the second embodiment, it is desirable that the intermediate group GM have a lens which satisfies the following conditional expression (15).

$$75. < vML \qquad ( 15 )$$

Where νML denotes an Abbe number of the lens in the intermediate group GM.

The conditional expression (15) defines an appropriate range of the Abbe number of the lens in the intermediate group GM. Because when the intermediate group GM has the lens which satisfies the conditional expression (15), a zoom optical system can be obtained in which a chromatic aberration is corrected and which provides excellent optical performance, such a zoom optical system is preferable. A lower limit value of the conditional expression (15) is set to 76.00, 77.50, 78.50, or further 80.00, and the effects of the present embodiment can thereby more certainly be obtained.

In the zoom optical system ZL according to the second embodiment, it is desirable that the intermediate group GM have, in a part of the intermediate group GM, the vibration proof group GVR which is movable to have a displacement component in a direction perpendicular to the optical axis. Accordingly, because a zoom optical system can be obtained which provides proper vibration proof performance while realizing size reduction and weight reduction, such a zoom optical system is preferable.

It is desirable that the zoom optical system ZL according to the second embodiment satisfy the following conditional expression (16).

$$0.01 < fMt / fVR < 1. \qquad ( 16 )$$

Where fVR denotes the focal length of the vibration proof group GVR.

The conditional expression (16) defines an appropriate relationship between the focal length of the intermediate group GM in the telephoto end state and the focal length of the vibration proof group GVR. By satisfying the conditional expression (16), the eccentric coma aberration and the asymmetrical field curves in a case where the image blur is corrected are thereby suppressed, and proper vibration proof performance can be obtained.

When a corresponding value of the conditional expression (16) exceeds an upper limit value, the focal length of the vibration proof group GVR becomes short, and it thereby becomes difficult to suppress the eccentric coma aberration and the asymmetrical field curves which occur in the vibration proof group GVR in a case where the image blur is corrected. The upper limit value of the conditional expression (16) is set to 0.85 or further 0.75, and the effects of the present embodiment can thereby more certainly be obtained.

When the corresponding value of the conditional expression (16) falls below a lower limit value, the focal length of the vibration proof group GVR becomes long, the movement amount of the vibration proof group GVR in a case where the image blur is corrected thereby becomes large, and it becomes difficult to suppress the eccentric coma aberration and the asymmetrical field curves. The lower limit value of the conditional expression (16) is set to 0.10, 0.25, 0.45, or further 0.60, and the effects of the present embodiment can thereby more certainly be obtained.

In the zoom optical system ZL according to the second embodiment, it is desirable that the vibration proof group GVR be arranged on a side of the intermediate group GM, the side being closest to the image surface. Accordingly, proper vibration proof performance can be obtained while the optical performance as the zoom optical system is maintained.

Further, it is desirable that the zoom optical system ZL according to the first embodiment and the second embodiment satisfy the following conditional expression (17).

$$0.01 < fVR / ( - fF ) < 2.5 \qquad ( 17 )$$

Where fVR denotes the focal length of the vibration proof group GVR, and

fF denotes the focal length of the focusing lens group GF.

The conditional expression (17) defines an appropriate relationship between the focal length of the vibration proof group GVR and the focal length of the focusing lens group GF. By satisfying the conditional expression (17), the eccentric coma aberration and the asymmetrical field curves in a case where the image blur is corrected are thereby suppressed, and proper vibration proof performance can be obtained.

When a corresponding value of the conditional expression (17) exceeds an upper limit value, the focal length of the vibration proof group GVR becomes long, the movement amount of the vibration proof group GVR in a case where the image blur is corrected thereby becomes large, and it becomes difficult to suppress the eccentric coma aberration and the asymmetrical field curves. Further, the focal length of the focusing lens group GF becomes short, and it thereby becomes difficult to correct the spherical aberration, the coma aberration, and the field curves which occur in the focusing lens group GF. The upper limit value of the conditional expression (17) is set to 2.00, 1.80, 1.65, or further 1.60, and the effects of each of the embodiments can thereby more certainly be obtained.

When the corresponding value of the conditional expression (17) falls below a lower limit value, the focal length of the vibration proof group GVR becomes short, and it thereby becomes difficult to suppress the eccentric coma aberration and the asymmetrical field curves which occur in the vibration proof group GVR in a case where the image blur is corrected. Further, the focal length of the focusing lens group GF becomes long, the movement amount of the focusing lens group GF in focusing thereby becomes large, and it becomes difficult to suppress fluctuations in the spherical aberration, the coma aberration, and the field curves when focusing is performed. The lower limit value of the conditional expression (17) is set to 0.10, 0.40, 0.63, 0.70, or further 1.00, and the effects of each of the embodiments can thereby more certainly be obtained.

In the zoom optical system ZL according to the first embodiment and the second embodiment, it is desirable that the vibration proof group GVR consist of two lenses. Accordingly, fluctuations in the chromatic aberration in a case where the image blur is corrected can be suppressed.

It is desirable that the zoom optical system ZL according to the first embodiment and the second embodiment satisfy the following conditional expression (18).

$$0.01 < ( - f 2 ) / f 1 < 1. \qquad ( 18 )$$

Where f1 denotes a focal length of the first lens group G1, and f2 denotes the focal length of the second lens group G2.

The conditional expression (18) defines an appropriate relationship between the focal length of the second lens group G2 and the focal length of the first lens group G1. By satisfying the conditional expression (18), the spherical aberration, the coma aberration, and the field curves can properly be corrected.

When a corresponding value of the conditional expression (18) exceeds an upper limit value, the focal length of the second lens group G2 becomes long, the movement amount of the second lens group G2 in zooming thereby becomes large, and it becomes difficult to suppress fluctuations in the spherical aberration, the coma aberration, and the field curves when zooming is performed. Further, the focal length of the first lens group G1 becomes short, and it thereby becomes difficult to correct the spherical aberration, the coma aberration, and the field curves which occur in the first lens group G1. The upper limit value of the conditional expression (18) is set to 0.75, 0.50, 0.30, 0.25, 0.20, or further 0.18, and the effects of each of the embodiments can thereby more certainly be obtained.

When the corresponding value of the conditional expression (18) falls below a lower limit value, the focal length of the second lens group G2 becomes short, and it thereby becomes difficult to correct the spherical aberration, the coma aberration, and the field curves which occur in the second lens group G2. Further, the focal length of the first lens group G1 becomes long, a movement amount of the first lens group G1 in zooming thereby becomes large, and it becomes difficult to suppress fluctuations in the spherical aberration, the coma aberration, and the field curves when zooming is performed. The lower limit value of the conditional expression (18) is set to 0.05, 0.10, or further 0.16, and the effects of each of the embodiments can thereby more certainly be obtained.

It is desirable that the zoom optical system ZL according to the first embodiment and the second embodiment satisfy the following conditional expression (19).

$$0.01 < TLt / ft < 2. \qquad ( 19 )$$

Where TLt denotes an entire length of the zoom optical system ZL in the telephoto end state, and

ft denotes the focal length of the zoom optical system ZL in the telephoto end state.

The conditional expression (19) defines an appropriate relationship between the entire length of the zoom optical system ZL in the telephoto end state and the focal length of the zoom optical system ZL in the telephoto end state. Note that in each of the embodiments, it is assumed that the entire length of the zoom optical system ZL is a distance on the optical axis from a lens surface on a side of the zoom optical system ZL, the side being closest to an object, to the image surface I (however, the distance on the optical axis from the lens surface on the side of the zoom optical system ZL, the side being closest to the image surface, to the image surface I is the air equivalent distance). It is preferable that the conditional expression (19) is satisfied, by which a zoom optical system, which provides excellent optical performance while realizing size reduction and weight reduction, can be obtained. An upper limit value of the conditional expression (19) is set to 1.75, 1.50, 1.35, 1.20, or further 1.19, and the effects of each of the embodiments can thereby more certainly be obtained. A lower limit value of the conditional expression (19) is set to 0.10, 0.50, or further 1.00, and the effects of each of the embodiments can thereby more certainly be obtained.

It is desirable that the zoom optical system ZL according to the first embodiment and the second embodiment satisfy the following conditional expression (20).

$$0.01 < β Ft / β Fw < 2. \qquad ( 20 )$$

Where βFt denotes a lateral magnification of the focusing lens group GF in the telephoto end state, and

βFw denotes the lateral magnification of the focusing lens group GF in the wide angle end state.

The conditional expression (20) defines an appropriate relationship between the lateral magnification of the focusing lens group GF in the telephoto end state and the lateral magnification of the focusing lens group GF in the wide angle end state. It is preferable that the conditional expression (20) is satisfied, by which a zoom optical system, which provides excellent optical performance while realizing size reduction and weight reduction, can be obtained. An upper limit value of the conditional expression (20) is set to 1.80, 1.65, 1.50, or further 1.35, and the effects of each of the embodiments can thereby more certainly be obtained. A lower limit value of the conditional expression (20) is set to 0.10, 0.50, 0.85, 0.90, 1.20, or further 1.21, and the effects of each of the embodiments can thereby more certainly be obtained.

In the zoom optical system ZL according to the first embodiment and the second embodiment, it is desirable that the focusing lens group GF consist of two lenses. Accordingly, fluctuations in the chromatic aberration when focusing is performed can be suppressed.

In the zoom optical system ZL according to the first embodiment and the second embodiment, it is desirable that the first lens group G1 have a lens which satisfies the following conditional expression (21).

$$75. < v 1 L \qquad ( 21 )$$

Where ν1L denotes an Abbe number of the lens in the first lens group G1.

The conditional expression (21) defines an appropriate range of the Abbe number of the lens in the first lens group G1. Because when the first lens group G1 has the lens which satisfies the conditional expression (21), a zoom optical system can be obtained in which the chromatic aberration is corrected and which provides excellent optical performance, such a zoom optical system is preferable. A lower limit value of the conditional expression (21) is set to 76.00, 77.50, 78.50, or further 80.00, and the effects of the present embodiment can thereby more certainly be obtained.

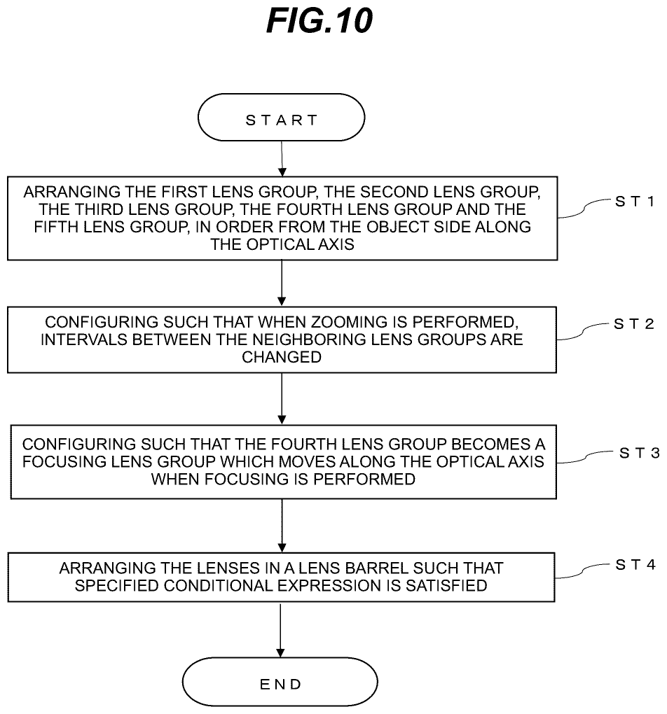

Next, a method for manufacturing the zoom optical system ZL according to the first embodiment will be outlined with reference to FIG. 10. First, in order from the object side along the optical axis, the first lens group G1 having positive refractive power, the second lens group G2 having negative refractive power, the third lens group G3 having positive refractive power, the fourth lens group G4 having negative refractive power, and the fifth lens group G5 having negative refractive power are arranged (step ST1). Next, a configuration is made such that when zooming is performed, intervals between the neighboring lens groups are changed (step ST2). Next, a configuration is made such that the fourth lens group G4 becomes a focusing lens group which moves along the optical axis when focusing is performed (step ST3). Furthermore, each of the lenses is arranged in a lens barrel such that at least the above conditional expression (1) is satisfied (step ST4). In such a manufacturing method, it becomes possible to manufacture a zoom optical system which provides excellent optical performance while realizing size reduction and weight reduction.

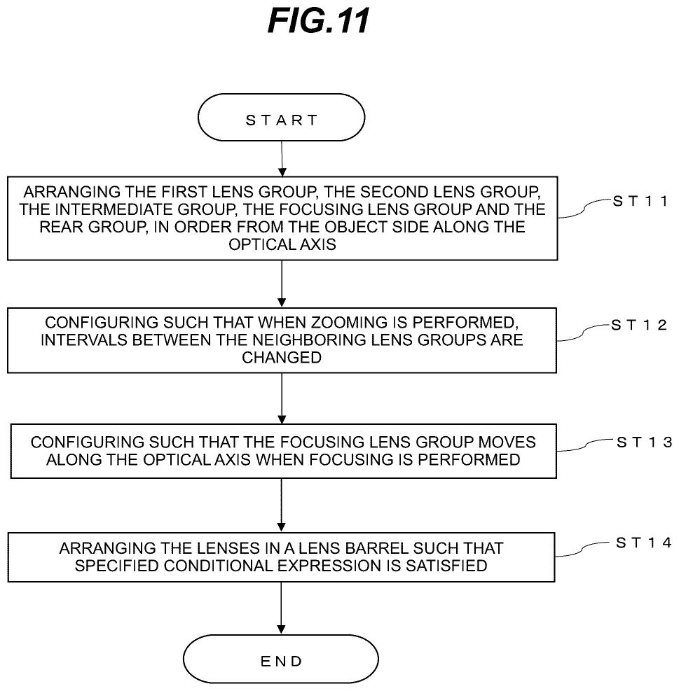

Next, a method for manufacturing the zoom optical system ZL according to the second embodiment will be outlined with reference to FIG. 11. First, in order from the object side along the optical axis, the first lens group G1 having positive refractive power, the second lens group G2 having negative refractive power, the intermediate group GM which has at least one lens group and which has positive refractive power, the focusing lens group GF having negative refractive power, and the rear group GR having at least one lens group are arranged (step ST11). Next, a configuration is made such that when zooming is performed, intervals between the neighboring lens groups are changed (step ST12). Next, a configuration is made such that the focusing lens group GF moves along the optical axis when focusing is performed (step ST13). Furthermore, each of the lenses is arranged in a lens barrel such that at least the above conditional expression (9) and conditional expression (6) are satisfied (step ST14). In such a manufacturing method, it becomes possible to manufacture a zoom optical system which provides excellent optical performance while realizing size reduction and weight reduction.

### EXAMPLES

In the following, the respective zoom optical systems ZL according to examples of each of the embodiments will be described based on the drawings. FIG. 1, FIG. 3, FIG. 5, and FIG. 7 are cross-sectional views which respectively illustrate configurations and refractive power distributions of the zoom optical systems ZL {ZL(1) to ZL(4)}according to first to fourth examples. Note that the examples which correspond to the first embodiment are the first to third examples, and the examples which correspond to the second embodiment are the first to fourth examples. In the cross-sectional views of the zoom optical systems ZL(1) to ZL(4) according to the first to fourth examples, a movement direction of each of the lens groups when zooming is performed from the wide angle end state (W) to the telephoto end state (T) is indicated by an arrow. Further, a movement direction of the focusing lens group when focusing is performed from infinity to a short-distance object is indicated by an arrow with characters of “FOCUSING”. A movement direction of the vibration proof group in a case where the image blur is corrected is indicated by an arrow with characters of “VIBRATION PROOF”.

In FIG. 1, FIG. 3, FIG. 5, and FIG. 7, each of the lens groups is denoted by a combination of a reference character G and a numeral, and each of the lenses is denoted by a combination of a reference character L and a numeral. In this case, in order to prevent a situation where kinds and the numbers of reference characters and numerals are increased and cause complication, lens groups and so forth are denoted by using independent combinations of reference characters and numerals for each of the examples. Thus, even when the same combinations of reference characters and numerals are used among the examples, this does not mean the same configurations.

Table 1 to table 4 are indicated in the following, and among those, the table 1, the table 2, the table 3, and the table 4 are tables which represent respective data of the first example, the second example, the third example, and the fourth example. In each of the examples, as targets of calculation of aberration characteristics, a d-line (wavelength λ=587.6 nm) and a g-line (wavelength λ=435.8 nm) are selected.

In a table of [General Data], f denotes a focal length of a whole lens system, FNO denotes an F-number, ω denotes a half angle of view (whose unit is “°” (degree)), and Y denotes an image height. A term TL denotes a distance in which Bf (back focal length) is added to a distance on the optical axis from the lens surface on the side of the zoom optical system upon focusing on infinity, the side being closest to the object, to the lens surface on the side closest to the image surface, and Bf denotes a distance (air equivalent distance) on the optical axis from the lens surface on the side of the zoom optical system upon focusing on infinity, the side being closest to the image surface, to the image surface. A term fM denotes the focal length of the intermediate group, and a term fR denotes the focal length of the rear group. Note that those values are indicated for each zooming state of wide angle end (W) and telephoto end (T).

Further, in the table of [General Data], a term fF denotes the focal length of the focusing lens group. A term fVR denotes the focal length of the vibration proof group. A term fFRt denotes the combined focal length of the focusing lens group in the telephoto end state and at least one lens group of the rear group. A term f45t denotes the combined focal length of the fourth lens group and the fifth lens group in the telephoto end state. A term PFw denotes the lateral magnification of the focusing lens group in the wide angle end state. A term βFt denotes the lateral magnification of the focusing lens group in the telephoto end state. A term βRw denotes the lateral magnification of the rear group in the wide angle end state. A term βRt denotes the lateral magnification of the rear group in the telephoto end state. A term β4w denotes a lateral magnification of the fourth lens group in the wide angle end state. A term β4t denotes a lateral magnification of the fourth lens group in the telephoto end state. A term β5w denotes the lateral magnification of the fifth lens group in the wide angle end state. A term β5t denotes the lateral magnification of the fifth lens group in the telephoto end state.

In a table of [Lens Data], a surface number denotes order of optical surfaces from the object side along a direction in which a beam of light progresses, R denotes a radius of curvature of each of the optical surfaces (a positive value is given to a surface whose center of curvature is positioned on an image side), D denotes a surface distance as a distance on the optical axis from each of the optical surfaces to the next optical surface (or the image surface), nd denotes a refractive index of a material of an optical member with respect to the d-line, and νd denotes the Abbe number of the material of the optical member with respect to the d-line as a reference. A radius of curvature of “∞” denotes a flat surface or an opening, and (aperture stop S) denotes the aperture stop S. A refractive index nd of air=1.00000 is not indicated. In a case where the optical surface is an aspherical surface, “*” sign is given to the surface number, and a paraxial radius of curvature is indicated in a field of the radius of curvature R.

In a table of [Aspherical Surface Data], a shape of an aspherical surface indicated in [Lens Data] is expressed by the following expression (A). A term X(y) denotes a distance (sag quantity), along an optical axis direction, from a tangential plane at an apex of the aspherical surface to a position on the aspherical surface at a height y, R denotes a radius of curvature (paraxial radius of curvature) of a reference spherical surface, κ denotes a conic constant, and Ai denotes an aspherical coefficient at the ith order. A term “E-n” denotes “×10⁻ⁿ”. For example, 1.234E-05=1.234×10⁻⁵. Note that an aspherical coefficient A2 at the second order is zero and is not indicated.

$$X ( y ) = ( {y}^{2} / R ) / \{ 1 + {( 1 - κ \times {y}^{2} / {R}^{2} )}^{1 / 2} \} + A 4 \times {y}^{4} + A 6 \times {y}^{6} + A 8 \times {y}^{8} + A 10 \times {y}^{10} \qquad ( A )$$

A table of [Variable Distance Data] indicates each surface distance at a surface number i for which the surface distance is (Di) in the table of [Lens Data]. Further, the table of [Variable Distance Data] indicates each surface distance upon focusing on infinity and each surface distance upon focusing on a very-short-distance object.

A table of [Lens Group Data] indicates a first surface (a surface on a side closest to the object) and a focal length of each of the lens groups.

In the following, in all of data values, “mm” is in general used for focal lengths f, radii of curvature R, surface distances D, other lengths, and so forth, which are raised herein, unless otherwise mentioned; however, this is not restrictive because the optical system can obtain equivalent optical performance even when the optical system is proportionally enlarged or proportionally shrunk.

The above descriptions about the tables are common to all of the examples, and the descriptions will not be repeated in the following.

### First Example

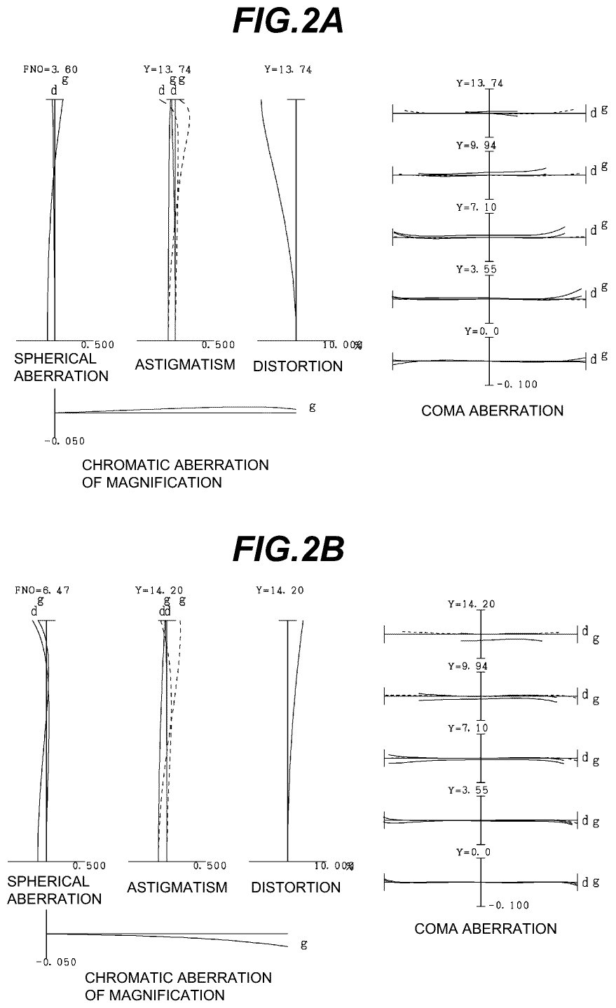

The first example will be described by using FIG. 1, FIGS. 2A and 2B, and the table 1. FIG. 1 is a diagram illustrating a lens configuration of the zoom optical system according to the first example. The zoom optical system ZL(1) according to the first example includes the first lens group G1 having positive refractive power, the second lens group G2 having negative refractive power, the third lens group G3 having positive refractive power, the fourth lens group G4 having negative refractive power, and the fifth lens group G5 having negative refractive power, which are aligned in order from the object side along the optical axis. When zooming is performed from the wide angle end state (W) to the telephoto end state (T), the first lens group G1 moves to the object side along the optical axis, the second lens group G2 temporarily moves to the image surface side along the optical axis and thereafter moves to the object side, the third lens group G3, the fourth lens group G4, and the fifth lens group G5 move to the object side along the optical axis, and the intervals between the neighboring lens groups are changed. Further, the aperture stop S is arranged between the second lens group G2 and the third lens group G3, and the aperture stop S moves along the optical axis together with the third lens group G3 when zooming is performed. A reference character (+) or (−) given to each lens group character indicates refractive power of each lens group, and the same applies to all of the following examples.

The first lens group G1 includes a cemented lens of a negative meniscus lens L11 having a convex surface facing the object and a biconvex positive lens L12, and a positive meniscus lens L13 having a convex surface facing the object, the above lenses L11, L12, and L13 being aligned in order from the object side along the optical axis.

The second lens group G2 includes a negative meniscus lens L21 having a convex surface facing the object, a biconcave negative lens L22, a biconvex positive lens L23, and a negative meniscus lens L24 having a concave surface facing the object, the above lenses L21, L22, L23, and L24 being aligned in order from the object side along the optical axis.

The third lens group G3 includes a biconvex positive lens L31, a biconvex positive lens L32, a cemented lens in which a negative meniscus lens L33 having a convex surface facing the object and a biconvex positive lens L34 are joined together, and a cemented lens in which a biconvex positive lens L35 and a negative meniscus lens L36 having a concave surface facing the object are joined together, the above lenses L31, L32, L33, L34, L35, and L36 being aligned in order from the object side along the optical axis. The positive lens L31 is a hybrid type lens which is configured by providing a resin layer on a surface of a glass-formed lens main body on the object side. A surface of the resin layer on the object side is an aspherical surface, and the positive lens L31 is a composite-type aspherical surface lens. In [Lens Data] described later, a surface number 15 indicates a surface of the resin layer on the object side, a surface number 16 indicates a surface of the resin layer on the image surface side and a surface of the lens main body on the object side (surfaces on which both of those are joined together), and a surface number 17 indicates a surface of the lens main body on the image surface side. The positive lens L35 is also a hybrid type lens which is configured by providing a resin layer on a surface of a glass-formed lens main body on the object side. A surface of the resin layer on the object side is an aspherical surface, and the positive lens L35 is also a composite-type aspherical surface lens. In [Lens Data] described later, a surface number 23 indicates a surface of the resin layer on the object side, a surface number 24 indicates a surface of the resin layer on the image surface side and a surface of the lens main body on the object side (surfaces on which both of those are joined together), and a surface number 25 indicates a surface of the lens main body on the image surface side (a surface which is joined to the negative meniscus lens L36).

The fourth lens group G4 includes a cemented lens in which a biconvex positive lens L41 and a biconcave negative lens L42 are joined together in order from the object side.

The fifth lens group G5 includes a negative meniscus lens L51 having a concave surface facing the object and a positive meniscus lens L52 having a concave surface facing the object, the above lenses L51 and L52 being aligned in order from the object side along the optical axis. The image surface I is arranged on the image side of the fifth lens group G5. Further, a parallel flat plate PP is arranged between the fifth lens group G5 and the image surface I.

In the present example, the third lens group G3 constitutes the intermediate group GM which, as a whole, has positive refractive power. Furthermore, the positive lens L35 and the negative meniscus lens L36 which are arranged on the side of the third lens group G3 (that is, the intermediate group GM), the side being closest to the image surface, constitute the vibration proof group GVR which is movable to have a displacement component in a direction perpendicular to the optical axis. Further, the fourth lens group G4 corresponds to the focusing lens group GF which moves along the optical axis when focusing is performed. When focusing is performed from an object at infinity to a short-distance object, the focusing lens group GF (the whole fourth lens group G4) moves to the image surface side along the optical axis. Further, the fifth lens group G5 constitutes the rear group GR which, as a whole, has negative refractive power.

The following table 1 raises values of data of the zoom optical system according to the first example.

TABLE 1
[General Data]
Zooming ratio = 7.327

| | |
|---|---|
| fF = −44.045 | fVR=28.900 |
| fFRt = −26.761 | f45t =- 26.761 |
| βFw = 1.530 | βFt = 1.951 |
| βRw = 1.182 | βRt = 1.461 |
| β4w = 1.530 | β4t = 1.951 |
| β5w = 1.182 | β5t = 1.461 |

| | W | M | T |
|---|---|---|---|
| f | 18.540 | 50.034 | 135.845 |
| FNO | 3.604 | 4.938 | 6.486 |
| ω | 39.178 | 15.279 | 5.740 |
| Y | 13.741 | 14.200 | 14.200 |
| TL | 102.842 | 118.968 | 150.558 |
| Bf | 10.327 | 20.923 | 35.271 |
| fM | 19.995 | 19.995 | 19.995 |
| fR | −89.364 | −89.364 | −89.364 |

[Lens Data]

| Surface | | | | | |
|---|---|---|---|---|---|
| Number | R | D | nd | νd | |
| 1 | 78.364 | 1.650 | 1.80518 | 25.45 | |
| 2 | 51.125 | 6.080 | 1.49782 | 82.57 | |
| 3 | −1387.433 | 0.100 | | | |
| 4 | 51.002 | 3.950 | 1.48749 | 70.31 | |
| 5 | 408.278 | (D5) | | | |
| 6 | 105.667 | 1.000 | 1.83481 | 42.73 | |
| 7 | 13.538 | 5.877 | | | |
| 8 | −40.384 | 1.000 | 1.74400 | 44.81 | |
| 9 | 40.384 | | | | |
| 10 | 26.016 | 3.250 | 1.80809 | 22.74 | |
| 11 | −43.626 | 0.840 | | | |
| 12 | −21.186 | 0.900 | 1.77250 | 49.62 | |
| 13 | −113.505 | (D13) | | | |
| 14 | ∞ | 1.500 | | | (Aperture |
| | | | | | Stop S) |
| 15* | 16.582 | 0.150 | 1.56093 | 36.64 | |
| 16 | 17.341 | 3.350 | 1.51742 | 52.20 | |
| 17 | −499.849 | 1.000 | | | |
| 18 | 54.519 | 1.560 | 1.60342 | 38.03 | |
| 19 | −1162.912 | 4.249 | | | |
| 20 | 287.817 | 0.950 | 2.00100 | 29.12 | |
| 21 | 15.000 | 3.900 | 1.49782 | 82.57 | |
| 22 | −33.047 | 1.000 | | | |
| 23* | 20.944 | 0.150 | 1.56093 | 36.64 | |
| 24 | 20.408 | 4.560 | 1.51680 | 64.14 | |
| 25 | −27.508 | 0.900 | 1.66755 | 41.87 | |
| 26 | −40.524 | (D26) | | | |
| 27 | 164.872 | 1.800 | 2.00100 | 29.12 | |
| 28 | −37.498 | 0.900 | 1.80400 | 46.60 | |
| 29 | 23.384 | (D29) | | | |
| 30 | −16.370 | 1.100 | 1.90265 | 35.77 | |
| 31 | −32.544 | 0.100 | | | |
| 32 | −502.457 | 2.080 | 1.84666 | 23.80 | |
| 33 | −52.880 | (D33) | | | |
| 34 | ∞ | 1.600 | 1.51680 | 64.14 | |
| 35 | ∞ | 1.000 | | | |

[Aspherical Surface Data]
15th Surface
κ = 1.0000, A4 = −2.96855E−05, A6 = −5.04688E−08,
A8 = −4.78359E−12, A10 = 0.00000E+00
23rd Surface
κ = 1.0000, A4 = −1.94678E−05, A6 = −1.10034E−08,
A8 = −1.10745E−10, A10 = 0.00000E+00
[Variable Distance Data]

| | | |
|---|---|---|
| W | M | T |

Upon focusing on infinity

| | | | |
|---|---|---|---|
| Focal length | 18.540 | 50.034 | 135.845 |
| Distance | ∞ | ∞ | ∞ |
| D5 | 1.137 | 18.064 | 38.687 |
| D13 | 20.855 | 6.402 | 2.040 |
| D26 | 1.935 | 6.290 | 1.909 |
| D29 | 13.983 | 12.681 | 18.046 |
| D33 | 8.272 | 18.869 | 33.216 |

Upon focusing on a very short distance object

| | | | |
|---|---|---|---|
| Magnification | −0.151 | −0.147 | −0.333 |
| Distance | 96.613 | 280.487 | 248.897 |
| D5 | 1.137 | 18.064 | 38.687 |
| D13 | 20.855 | 6.402 | 2.040 |
| D26 | 3.492 | 8.922 | 10.681 |
| D29 | 12.425 | 10.049 | 9.274 |
| D33 | 8.272 | 18.869 | 33.216 |

[Lens Group Data]

| | First | Focal |
|---|---|---|
| Group | Surface | length |
| G1 | 1 | 77.833 |
| G2 | 6 | −13.200 |
| G3 | 14 | 19.995 |
| G4 | 27 | −44.045 |
| G5 | 30 | −89.364 |

FIG. 2A illustrates diagrams of various aberrations of the zoom optical system according to the first example upon focusing on infinity in the wide angle end state. FIG. 2B illustrates diagrams of various aberrations of the zoom optical system according to the first example upon focusing on infinity in the telephoto end state. In each of the diagrams of aberrations, FNO denotes the F-number, and Y denotes the image height. Note that a spherical aberration diagram indicates the value of the F-number which corresponds to the maximum aperture, an astigmatism diagram and a distortion diagram respectively indicate the maximum values of the image height, and a coma aberration diagram indicates the value of each image height. A reference character d denotes the d-line (wavelength λ=587.6 nm), and a reference character g denotes the g-line (wavelength λ=435.8 nm). In the astigmatism diagram, a solid line indicates a sagittal image surface, and a broken line indicates a meridional image surface. Note that also in diagrams of aberrations in each of the examples, which will be described in the following, similar reference characters to the present example will be used, and descriptions thereof will not be repeated.

Based on each of the diagrams of various aberrations, it may be understood that the zoom optical system according to the first example properly corrects various aberrations from the wide angle end state to the telephoto end state and provides excellent image formation performance.

### Second Example

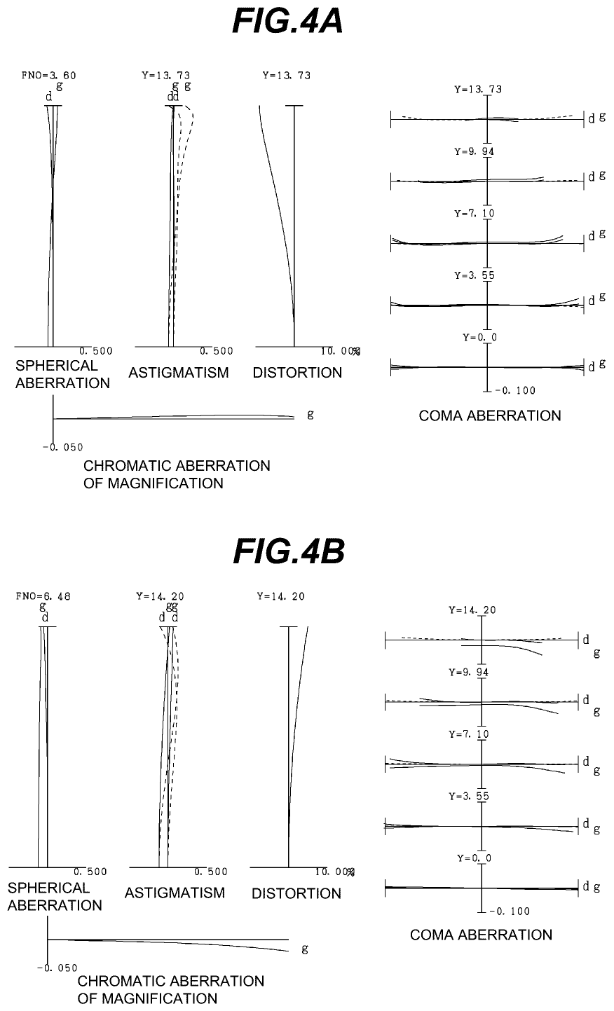

The second example will be described by using FIG. 3, FIGS. 4A and 4B, and the table 2. FIG. 3 is a diagram illustrating a lens configuration of a zoom optical system according to the second example. The zoom optical system ZL(2) according to the second example includes the first lens group G1 having positive refractive power, the second lens group G2 having negative refractive power, the third lens group G3 having positive refractive power, the fourth lens group G4 having negative refractive power, and the fifth lens group G5 having negative refractive power, which are aligned in order from the object side along the optical axis. When zooming is performed from the wide angle end state (W) to the telephoto end state (T), the first lens group G1 moves to the object side along the optical axis, the second lens group G2 temporarily moves to the image surface side along the optical axis and thereafter moves to the object side, the third lens group G3, the fourth lens group G4, and the fifth lens group G5 move to the object side along the optical axis, and the intervals between the neighboring lens groups are changed. Further, the aperture stop S is arranged between the second lens group G2 and the third lens group G3, and the aperture stop S moves along the optical axis together with the third lens group G3 when zooming is performed.

In the second example, because the first lens group G1, the second lens group G2, the fourth lens group G4, and the fifth lens group G5 are configured as in the first example, the same reference characters as the case of the first example are given, and detailed descriptions about those lenses will not be made.

The third lens group G3 includes a biconvex positive lens L31, a positive meniscus lens L32 having a convex surface facing the object, a cemented lens in which a negative meniscus lens L33 having a convex surface facing the object and a biconvex positive lens L34 are joined together, and a cemented lens in which a biconvex positive lens L35 and a negative meniscus lens L36 having a concave surface facing the object are joined together, the above lenses L31, L32, L33, L34, L35, and L36 being aligned in order from the object side along the optical axis. The positive lens L31 is a hybrid type lens which is configured by providing a resin layer on a surface of a glass-formed lens main body on the object side. A surface of the resin layer on the object side is an aspherical surface, and the positive lens L31 is a composite-type aspherical surface lens. In [Lens Data] described later, a surface number 15 indicates a surface of the resin layer on the object side, a surface number 16 indicates a surface of the resin layer on the image surface side and a surface of the lens main body on the object side (surfaces on which both of those are joined together), and a surface number 17 indicates a surface of the lens main body on the image surface side. The positive lens L35 is also a hybrid type lens which is configured by providing a resin layer on a surface of a glass-formed lens main body on the object side. A surface of the resin layer on the object side is an aspherical surface, and the positive lens L35 is also a composite-type aspherical surface lens. In [Lens Data] described later, a surface number 23 indicates a surface of the resin layer on the object side, a surface number 24 indicates a surface of the resin layer on the image surface side and a surface of the lens main body on the object side (surfaces on which both of those are joined together), and a surface number 25 indicates a surface of the lens main body on the image surface side (a surface which is joined to the negative meniscus lens L36).

In the present example, the third lens group G3 constitutes the intermediate group GM which, as a whole, has positive refractive power. Furthermore, the positive lens L35 and the negative meniscus lens L36 which are arranged on the side of the third lens group G3 (that is, the intermediate group GM), the side being closest to the image surface, constitute the vibration proof group GVR which is movable to have a displacement component in a direction perpendicular to the optical axis. Further, the fourth lens group G4 corresponds to the focusing lens group GF which moves along the optical axis when focusing is performed. When focusing is performed from an object at infinity to a short-distance object, the focusing lens group GF (the whole fourth lens group G4) moves to the image surface side along the optical axis. Further, the fifth lens group G5 constitutes the rear group GR which, as a whole, has negative refractive power.

The following table 2 raises values of data of the zoom optical system according to the second example.

TABLE 2
[General Data]
Zooming ratio = 7.313

| | |
|---|---|
| fF = −40.918 | fVR = 30.427 |
| fFRt = −29.177 | f45t = −29.177 |
| βFw = 1.592 | βFt = 2.058 |
| βRw = 1.154 | βRt = 1.338 |
| β4w = 1.592 | β4t = 2.058 |
| β5w = 1.154 | β5t = 1.338 |

| | W | M | T |
|---|---|---|---|
| f | 18.540 | 50.000 | 135.580 |
| FNO | 3.605 | 4.898 | 6.487 |
| ω | 39.148 | 15.062 | 5.697 |
| Y | 13.734 | 14.200 | 14.200 |
| TL | 102.355 | 119.632 | 150.055 |
| Bf | 10.305 | 20.056 | 33.956 |
| fM | 19.597 | 19.597 | 19.597 |
| fR | −128.502 | −128.502 | −128.502 |

[Lens Data]

| Surface | | | | | |
|---|---|---|---|---|---|
| Number | R | D | nd | νd | |
| 1 | 77.089 | 1.650 | 1.80518 | 25.45 | |
| 2 | 50.017 | 5.759 | 1.49700 | 81.61 | |
| 3 | −3731.534 | 0.100 | | | |
| 4 | 55.411 | 3.987 | 1.51680 | 63.88 | |
| 5 | 606.340 | (D5) | | | |
| 6 | 71.182 | 1.000 | 1.83481 | 42.73 | |
| 7 | 12.765 | 5.103 | | | |
| 8 | −32.874 | 1.000 | 1.83481 | 42.73 | |
| 9 | 57.757 | 0.599 | | | |
| 10 | 29.824 | 2.802 | 1.92286 | 20.88 | |
| 11 | −53.069 | 1.055 | | | |
| 12 | −19.343 | 1.000 | 1.83481 | 42.73 | |
| 13 | −54.386 | (D13) | | | |
| 14 | ∞ | 1.500 | | | (Aperture |
| | | | | | Stop S) |
| 15* | 17.533 | 0.200 | 1.56093 | 36.64 | |
| 16 | 19.709 | 2.971 | 1.51742 | 52.20 | |
| 17 | −532.437 | 1.000 | | | |
| 18 | 36.670 | 1.847 | 1.59270 | 35.27 | |
| 19 | 141.326 | 3.709 | | | |
| 20 | 118.256 | 1.000 | 2.00100 | 29.13 | |
| 21 | 14.872 | 3.665 | 1.49700 | 81.61 | |
| 22 | −35.608 | 1.000 | | | |
| 23* | 23.806 | 0.200 | 1.56093 | 36.64 | |
| 24 | 27.593 | 3.799 | 1.51680 | 63.88 | |
| 25 | −28.440 | 0.900 | 2.00069 | 25.46 | |
| 26 | −34.910 | (D26) | | | |
| 27 | 132.182 | 2.693 | 1.85000 | 27.03 | |
| 28 | −17.587 | 1.000 | 1.80100 | 34.92 | |
| 29 | 23.474 | (D29) | | | |
| 30 | −15.338 | 1.200 | 1.83481 | 42.73 | |
| 31 | −28.528 | 0.100 | | | |
| 32 | −150.496 | 2.229 | 1.84666 | 23.78 | |
| 33 | −40.999 | (D33) | | | |
| 34 | ∞ | 1.600 | 1.51680 | 64.13 | |
| 35 | ∞ | 1.000 | | | |

[Aspherical Surface Data]
15th Surface
κ = 1.0000, A4 = −2.77917E−05, A6 = −3.74974E−08,
A8 = 5.24965E−11, A10 = 0.00000E+00
23rd Surface
κ = 1.0000, A4 = −1.89584E−05, A6 = 1.08869E−08,
A8 = −1.42329E−10, A10 = 0.00000E+00
[Variable Distance Data]

| | | |
|---|---|---|
| W | M | T |

Upon focusing on infinity

| | | | |
|---|---|---|---|
| Focal length | 18.540 | 50.000 | 135.580 |
| Distance | ∞ | ∞ | ∞ |
| D5 | 1.150 | 20.019 | 39.281 |
| D13 | 21.142 | 7.098 | 2.000 |
| D26 | 2.000 | 6.706 | 3.303 |
| D29 | 14.691 | 12.686 | 18.448 |
| D33 | 8.250 | 18.001 | 31.901 |

Upon focusing on a very short distance object

| | | | |
|---|---|---|---|
| Magnification | −0.152 | −0.145 | −0.335 |
| Distance | 97.100 | 279.823 | 249.400 |
| D5 | 1.150 | 20.019 | 39.281 |
| D13 | 21.142 | 7.098 | 2.000 |
| D26 | 3.429 | 9.344 | 12.441 |
| D29 | 13.262 | 10.048 | 9.310 |
| D33 | 8.250 | 18.001 | 31.901 |

[Lens Group Data]

| | First | Focal |
|---|---|---|
| Group | Surface | length |
| G1 | 1 | 78.430 |
| G2 | 6 | −12.938 |
| G3 | 14 | 19.597 |
| G4 | 27 | −40.918 |
| G5 | 30 | −128.502 |

FIG. 4A illustrates diagrams of various aberrations of the zoom optical system according to the second example upon focusing on infinity in the wide angle end state. FIG. 4B illustrates diagrams of various aberrations of the zoom optical system according to the second example upon focusing on infinity in the telephoto end state. Based on each of the diagrams of various aberrations, it may be understood that the zoom optical system according to the second example properly corrects various aberrations from the wide angle end state to the telephoto end state and provides excellent image formation performance.

### Third Example

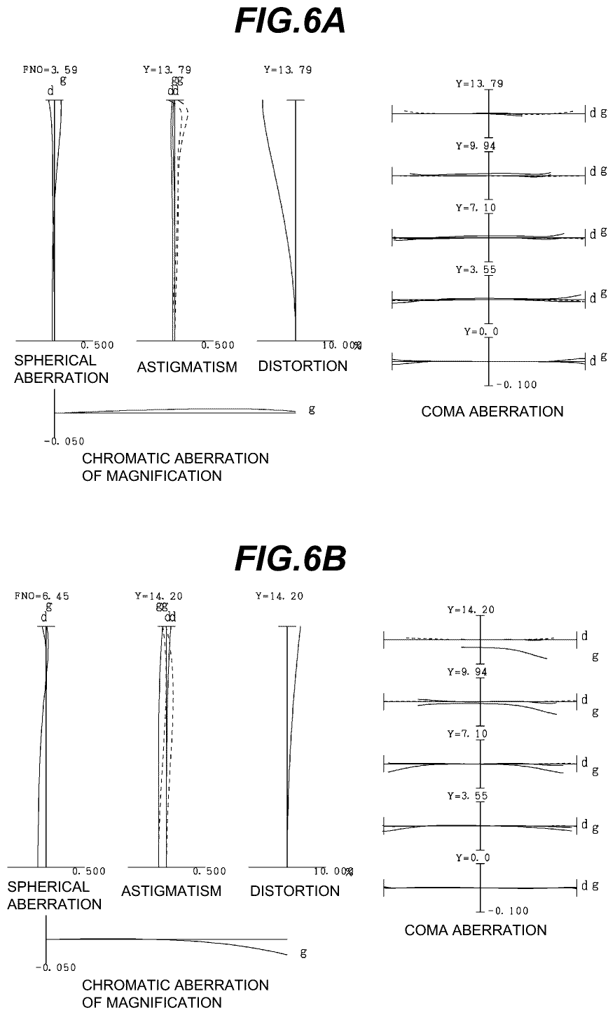

The third example will be described by using FIG. 5, FIGS. 6A and 6B, and the table 3. FIG. 5 is a diagram illustrating a lens configuration of a zoom optical system according to the third example. The zoom optical system ZL(3) according to the third example includes the first lens group G1 having positive refractive power, the second lens group G2 having negative refractive power, the third lens group G3 having positive refractive power, the fourth lens group G4 having negative refractive power, and the fifth lens group G5 having negative refractive power, which are aligned in order from the object side along the optical axis. When zooming is performed from the wide angle end state (W) to the telephoto end state (T), the first lens group G1, the second lens group G2, the third lens group G3, the fourth lens group G4, and the fifth lens group G5 move to the object side along the optical axis, and the intervals between the neighboring lens groups are changed. Further, the aperture stop S is arranged between the second lens group G2 and the third lens group G3, and the aperture stop S moves along the optical axis together with the third lens group G3 when zooming is performed.

In the third example, because the first lens group G1, the second lens group G2, and the fourth lens group G4 are configured as in the first example, the same reference characters as the case of the first example are given, and detailed descriptions about those lenses will not be made.

The third lens group G3 includes a biconvex positive lens L31, a cemented lens in which a biconvex positive lens L32 and a biconcave negative lens L33 are joined together, a biconvex positive lens L34, and a cemented lens in which a biconvex positive lens L35 and a negative meniscus lens L36 having a concave surface facing the object are joined together, the above lenses L31, L32, L33, L34, L35, and L36 being aligned in order from the object side along the optical axis. The positive lens L31 is a hybrid type lens which is configured by providing a resin layer on a surface of a glass-formed lens main body on the object side. A surface of the resin layer on the object side is an aspherical surface, and the positive lens L31 is a composite-type aspherical surface lens. In [Lens Data] described later, a surface number 15 indicates a surface of the resin layer on the object side, a surface number 16 indicates a surface of the resin layer on the image surface side and a surface of the lens main body on the object side (surfaces on which both of those are joined together), and a surface number 17 indicates a surface of the lens main body on the image surface side. The positive lens L35 is also a hybrid type lens which is configured by providing a resin layer on a surface of a glass-formed lens main body on the object side. A surface of the resin layer on the object side is an aspherical surface, and the positive lens L35 is also a composite-type aspherical surface lens. In [Lens Data] described later, a surface number 23 indicates a surface of the resin layer on the object side, a surface number 24 indicates a surface of the resin layer on the image surface side and a surface of the lens main body on the object side (surfaces on which both of those are joined together), and a surface number 25 indicates a surface of the lens main body on the image surface side (a surface which is joined to the negative meniscus lens L36).

The fifth lens group G5 includes a negative meniscus lens L51 having a concave surface facing the object and a biconvex positive lens L52, the above lenses L51 and L52 being aligned in order from the object side along the optical axis. The image surface I is arranged on the image side of the fifth lens group G5. Further, the parallel flat plate PP is arranged between the fifth lens group G5 and the image surface I.

In the present example, the third lens group G3 constitutes the intermediate group GM which, as a whole, has positive refractive power. Furthermore, the positive lens L35 and the negative meniscus lens L36 which are arranged on the side of the third lens group G3 (that is, the intermediate group GM), the side being closest to the image surface, constitute the vibration proof group GVR which is movable to have a displacement component in a direction perpendicular to the optical axis. Further, the fourth lens group G4 corresponds to the focusing lens group GF which moves along the optical axis when focusing is performed. When focusing is performed from an object at infinity to a short-distance object, the focusing lens group GF (the whole fourth lens group G4) moves to the image surface side along the optical axis. Further, the fifth lens group G5 constitutes the rear group GR which, as a whole, has negative refractive power.

The following table 3 raises values of data of the zoom optical system according to the third example.

TABLE 3
[General Data]
Zooming ratio = 7.312

| | |
|---|---|
| fF = −37.129 | fVR = 29.958 |
| fFRt = −26.127 | f45t = −26.127 |
| βFw = 1.607 | βFt = 2.123 |
| βRw = 1.159 | βRt = 1.351 |
| β4w = 1.607 | β4t = 2.123 |
| β5w = 1.159 | β5t = 1.351 |

| | W | M | T |
|---|---|---|---|
| f | 18.540 | 49.998 | 135.573 |
| FNO | 3.605 | 5.012 | 6.453 |
| ω | 39.122 | 15.336 | 5.783 |
| Y | 13.794 | 14.200 | 14.200 |
| TL | 101.754 | 121.465 | 149.451 |
| Bf | 10.304 | 21.804 | 32.615 |
| fM | 19.253 | 19.253 | 19.253 |
| fR | −115.716 | −115.716 | −115.716 |

[Lens Data]

| Surface | | | | | |
|---|---|---|---|---|---|
| Number | R | D | nd | νd | |
| 1 | 73.519 | 1.650 | 1.80518 | 25.45 | |
| 2 | 48.434 | 6.102 | 1.49700 | 81.61 | |
| 3 | −2804.506 | 0.100 | | | |
| 4 | 56.181 | 3.859 | 1.51680 | 63.88 | |
| 5 | 464.308 | (D5) | | | |
| 6 | 61.160 | 1.000 | 1.83481 | 42.73 | |
| 7 | 12.720 | 5.196 | | | |
| 8 | −34.365 | 1.000 | 1.83481 | 42.73 | |
| 9 | 57.322 | 0.401 | | | |
| 10 | 29.582 | 2.704 | 1.92286 | 20.88 | |
| 11 | −59.703 | 1.156 | | | |
| 12 | −19.306 | 1.000 | 1.75500 | 52.34 | |
| 13 | −67.886 | (D13) | | | |
| 14 | ∞ | 1.500 | | | (Aperture |
| | | | | | Stop S) |
| 15* | 18.139 | 0.200 | 1.56093 | 36.64 | |
| 16 | 20.458 | 3.028 | 1.51742 | 52.20 | |
| 17 | −119.805 | 4.590 | | | |
| 18 | 25.116 | 2.965 | 1.57501 | 41.51 | |
| 19 | −275.984 | 1.000 | 2.00100 | 29.14 | |
| 20 | 17.695 | 0.247 | | | |
| 21 | 21.205 | 2.858 | 1.49700 | 81.61 | |
| 22 | −42.496 | 1.111 | | | |
| 23* | 24.421 | 0.200 | 1.56093 | 36.64 | |
| 24 | 28.545 | 4.380 | 1.51680 | 63.88 | |
| 25 | −18.889 | 0.900 | 2.00100 | 29.14 | |
| 26 | −26.089 | (D26) | | | |
| 27 | 193.701 | 3.264 | 1.85000 | 27.03 | |
| 28 | −14.147 | 1.000 | 1.80100 | 34.92 | |
| 29 | 22.767 | (D29) | | | |
| 30 | −13.687 | 1.200 | 1.83481 | 42.73 | |
| 31 | −26.599 | 0.100 | | | |
| 32 | 95.577 | 2.601 | 1.85000 | 27.03 | |
| 33 | −87.080 | (D33) | | | |
| 34 | ∞ | 1.600 | 1.51680 | 63.88 | |
| 35 | ∞ | 1.000 | | | |

[Aspherical Surface Data]
15th Surface
κ = 1.0000, A4 = −2.46352E−05, A6 = −6.76098E−08,
A8 = 3.13409E−10, A10 = 0.00000E+00
23rd Surface
κ = 1.0000, A4 = −2.19056E−05, A6 = 4.43054E−08,
A8 = −1.00568E−10, A10 = 0.00000E+00
[Variable Distance Data]

| | | |
|---|---|---|
| W | M | T |

Upon focusing on infinity

| | | | |
|---|---|---|---|
| Focal length | 18.540 | 49.998 | 135.573 |
| Distance | ∞ | ∞ | ∞ |
| D5 | 1.050 | 19.709 | 39.182 |
| D13 | 20.412 | 7.734 | 2.000 |
| D26 | 2.000 | 4.819 | 2.752 |
| D29 | 12.676 | 12.086 | 17.589 |
| D33 | 8.249 | 19.749 | 30.560 |

Upon focusing on a very short distance object

| | | | |
|---|---|---|---|
| Magnification | −0.150 | −0.146 | −0.331 |
| Distance | 97.701 | 277.990 | 250.004 |
| D5 | 1.050 | 19.709 | 39.182 |
| D13 | 20.412 | 7.734 | 2.000 |
| D26 | 3.364 | 6.963 | 10.836 |
| D29 | 11.313 | 9.942 | 9.505 |
| D33 | 8.249 | 19.749 | 30.560 |

[Lens Group Data]

| | First | Focal |
|---|---|---|
| Group | Surface | length |
| G1 | 1 | 78.669 |
| G2 | 6 | −12.882 |
| G3 | 14 | 19.253 |
| G4 | 27 | −37.129 |
| G5 | 30 | −115.716 |

FIG. 6A illustrates diagrams of various aberrations of the zoom optical system according to the third example upon focusing on infinity in the wide angle end state. FIG. 6B illustrates diagrams of various aberrations of the zoom optical system according to the third example upon focusing on infinity in the telephoto end state. Based on each of the diagrams of various aberrations, it may be understood that the zoom optical system according to the third example properly corrects various aberrations from the wide angle end state to the telephoto end state and provides excellent image formation performance.

### Fourth Example

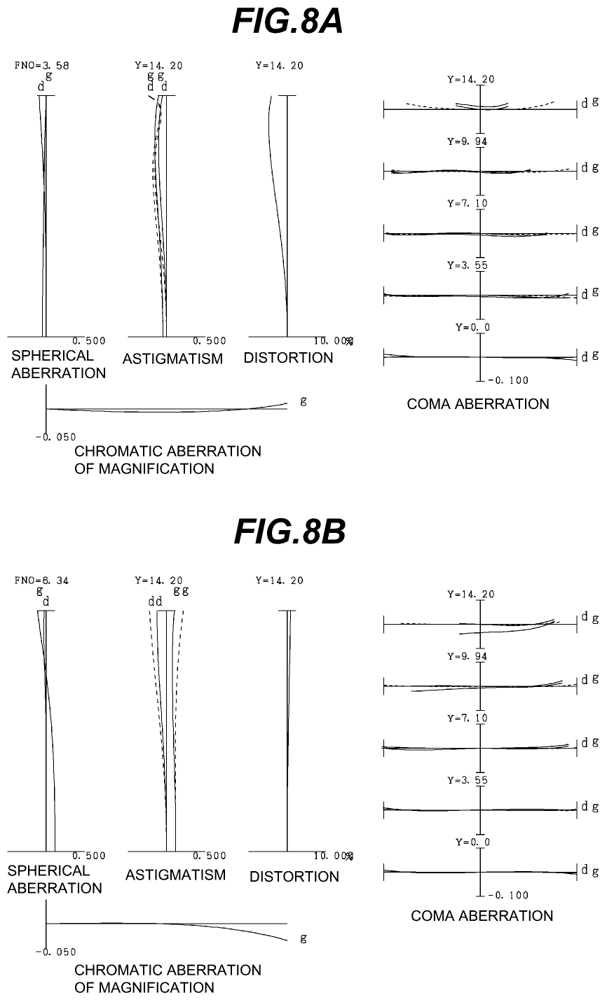

The fourth example will be described by using FIG. 7, FIGS. 8A and 8B, and the table 4. FIG. 7 is a diagram illustrating a lens configuration of a zoom optical system according to the fourth example. The zoom optical system ZL(4) according to the fourth example includes the first lens group G1 having positive refractive power, the second lens group G2 having negative refractive power, the third lens group G3 having positive refractive power, the fourth lens group G4 having positive refractive power, the fifth lens group G5 having negative refractive power, and a sixth lens group G6 having positive refractive power, which are aligned in order from the object side along the optical axis. When zooming is performed from the wide angle end state (W) to the telephoto end state (T), the first lens group G1, the second lens group G2, the third lens group G3, the fourth lens group G4, the fifth lens group G5, and the sixth lens group G6 move to the object side along the optical axis, and the intervals between the neighboring lens groups are changed. Further, the aperture stop S is arranged between the second lens group G2 and the third lens group G3, and the aperture stop S moves along the optical axis together with the third lens group G3 when zooming is performed.

The first lens group G1 includes a cemented lens of a negative meniscus lens L11 having a convex surface facing the object and a positive meniscus lens L12 having a convex surface facing the object, and a positive meniscus lens L13 having a convex surface facing the object, the above lenses L11, L12, and L13 being aligned in order from the object side along the optical axis.

The second lens group G2 includes a negative meniscus lens L21 having a convex surface facing the object, a biconcave negative lens L22, a biconvex positive lens L23, and a biconcave negative lens L24, the above lenses L21, L22, L23, and L24 being aligned in order from the object side along the optical axis.

The third lens group G3 includes a biconvex positive lens L31, a positive meniscus lens L32 having a convex surface facing the object, and a biconcave negative lens L33, the above lenses L31, L32, and L33 being aligned in order from the object side along the optical axis.

The fourth lens group G4 includes a biconvex positive lens L41 and a cemented lens in which a negative meniscus lens L42 having a convex surface facing the object and a biconvex positive lens L43 are joined together, the above lenses L41, L42, and L43 being aligned in order from the object side along the optical axis. The positive lens L41 is a hybrid type lens which is configured by providing a resin layer on a surface of a glass-formed lens main body on the object side. A surface of the resin layer on the object side is an aspherical surface, and the positive lens L41 is a composite-type aspherical surface lens. In [Lens Data] described later, a surface number 21 indicates a surface of the resin layer on the object side, a surface number 22 indicates a surface of the resin layer on the image surface side and a surface of the lens main body on the object side (surfaces on which both of those are joined together), and a surface number 23 indicates a surface of the lens main body on the image surface side.

The fifth lens group G5 includes a cemented lens in which a biconvex positive lens L51 and a biconcave negative lens L52 are joined together in order from the object side.

The sixth lens group G6 includes a negative meniscus lens L61 having a concave surface facing the object and a biconvex positive lens L62, the above lenses L61 and L62 being aligned in order from the object side along the optical axis. The image surface I is arranged on the image side of the sixth lens group G6. Further, the parallel flat plate PP is arranged between the sixth lens group G6 and the image surface I.

In the present example, the third lens group G3 and the fourth lens group G4 constitute the intermediate group GM which, as a whole, has positive refractive power. Furthermore, the positive lens L41 of the fourth lens group G4 constitutes the vibration proof group GVR which is movable to have a displacement component in a direction perpendicular to the optical axis. Further, the fifth lens group G5 corresponds to the focusing lens group GF which moves along the optical axis when focusing is performed. When focusing is performed from an object at infinity to a short-distance object, the focusing lens group GF (the whole fifth lens group G5) moves to the image surface side along the optical axis. Further, the sixth lens group G6 constitutes the rear group GR which, as a whole, has positive refractive power.

The following table 4 raises values of data of the zoom optical system according to the fourth example.

TABLE 4
[General Data]
Zooming ratio = 7.348

| | |
|---|---|
| fF = −29.503 | fVR = 25.327 |
| fFRt = −35.547 | |
| βFw = 1.801 | βFt = 2.880 |
| βRw = 1.012 | βRt = 0.941 |

| | W | M | T |
|---|---|---|---|
| f | 18.507 | 69.967 | 135.991 |
| FNO | 3.592 | 5.646 | 6.346 |
| ω | 38.657 | 11.301 | 5.911 |
| Y | 14.200 | 14.200 | 14.200 |
| TL | 103.497 | 130.917 | 148.519 |
| Bf | 10.783 | 28.603 | 36.638 |
| fM | 19.220 | 17.885 | 17.861 |
| fR | 365.857 | 365.857 | 365.857 |

[Lens Data]

| Surface | | | | | |
|---|---|---|---|---|---|
| Number | R | D | nd | νd | |
| 1 | 68.597 | 1.650 | 1.80518 | 25.45 | |
| 2 | 44.486 | 6.390 | 1.48749 | 70.31 | |
| 3 | 2147.717 | 0.100 | | | |
| 4 | 48.948 | 4.164 | 1.58913 | 61.22 | |
| 5 | 240.577 | (D5) | | | |
| 6 | 129.624 | 1.000 | 1.83481 | 42.73 | |
| 7 | 11.939 | 5.096 | | | |
| 8 | −32.648 | 1.000 | 1.80400 | 46.60 | |
| 9 | 102.523 | 0.100 | | | |
| 10 | 23.122 | 4.390 | 1.78472 | 25.64 | |
| 11 | −30.169 | 0.363 | | | |
| 12 | −23.466 | 1.000 | 1.80400 | 46.60 | |
| 13 | 125.146 | (D13) | | | |
| 14 | ∞ | 1.500 | | | (Aperture |
| | | | | | Stop S) |
| 15 | 40.213 | 2.735 | 1.48749 | 70.31 | |
| 16 | −23.799 | 0.100 | | | |
| 17 | 15.287 | 2.541 | 1.48749 | 70.31 | |
| 18 | 46.241 | 1.281 | | | |
| 19 | −26.779 | 1.000 | 1.65160 | 58.62 | |
| 20 | 44.829 | (D20) | | | |
| 21* | 24.441 | 0.250 | 1.56093 | 36.64 | |
| 22 | 25.854 | 3.563 | 1.51680 | 64.14 | |
| 23 | −26.825 | 0.500 | | | |
| 24 | 32.072 | 1.200 | 2.00100 | 29.12 | |
| 25 | 12.533 | 4.110 | 1.51680 | 64.14 | |
| 26 | −33.308 | (D26) | | | |
| 27 | 123.803 | 2.716 | 1.90200 | 25.26 | |
| 28 | −20.927 | 1.000 | 1.80100 | 34.92 | |
| 29 | 17.132 | (D29) | | | |
| 30 | −17.414 | 1.200 | 1.80400 | 46.60 | |
| 31 | −30.030 | 0.150 | | | |
| 32 | 42.914 | 3.585 | 1.62004 | 36.40 | |
| 33 | −101.277 | (D33) | | | |
| 34 | ∞ | 1.600 | 1.51680 | 64.14 | |
| 35 | ∞ | 1.000 | | | |

[Aspherical Surface Data]
21st Surface
κ = 1.0000, A4 = −5.28036E−05, A6 = 8.22302E−08,
A8 = 0.00000E+00, A10 = 0.00000E+00
[Variable Distance Data]

| | | |
|---|---|---|
| W | M | T |

Upon focusing on infinity

| | | | |
|---|---|---|---|
| Focal length | 18.507 | 69.967 | 135.991 |
| Distance | ∞ | ∞ | ∞ |
| D5 | 2.100 | 24.867 | 37.551 |
| D13 | 19.139 | 5.971 | 2.854 |
| D20 | 4.666 | 1.099 | 1.030 |
| D26 | 3.058 | 4.591 | 2.000 |
| D29 | 11.068 | 13.102 | 15.761 |
| D33 | 8.728 | 26.549 | 34.583 |

Upon focusing on a very short distance object

| | | | |
|---|---|---|---|
| Magnification | −0.151 | −0.201 | −0.341 |
| Distance | 95.958 | 268.538 | 250.936 |
| D5 | 2.100 | 24.867 | 37.551 |
| D13 | 19.139 | 5.971 | 2.854 |
| D20 | 4.666 | 1.099 | 1.030 |
| D26 | 4.313 | 7.653 | 10.037 |
| D29 | 9.812 | 10.040 | 7.724 |
| D33 | 8.728 | 26.549 | 34.583 |

[Lens Group Data]

| | First | Focal |
|---|---|---|
| Group | Surface | length |
| G1 | 1 | 72.234 |
| G2 | 6 | −12.115 |
| G3 | 14 | 42.713 |
| G4 | 21 | 21.508 |
| G5 | 27 | −29.503 |
| G6 | 30 | 365.857 |

FIG. 8A illustrates diagrams of various aberrations of the zoom optical system according to the fourth example upon focusing on infinity in the wide angle end state. FIG. 8B illustrates diagrams of various aberrations of the zoom optical system according to the fourth example upon focusing on infinity in the telephoto end state. Based on each of the diagrams of various aberrations, it may be understood that the zoom optical system according to the fourth example properly corrects various aberrations from the wide angle end state to the telephoto end state and provides excellent image formation performance.

Next, a table of [Conditional Expression Corresponding Values] will be indicated in the following. This table indicates, in a summarized manner, values corresponding to the conditional expressions (1) to (21) for all of the examples (first to fourth examples).

$$0.11 < f 4 / f 5 < 0.7 \qquad Conditional Expression ( 1 )$$

$$0.01 < ( - f 4 ) / f 3 < 5. \qquad Conditional Expression ( 2 )$$

$$0.01 < f 3 / ( - f 5 ) < 1. \qquad Conditional Expression ( 3 )$$

$$0.01 < f 3 / ( - f 45 t ) < 2. \qquad Conditional Expression ( 4 )$$

$$0.01 < β5 t / β5 w < 2. \qquad Conditional Expression ( 5 )$$

$$0.01 < Bfw / fw < 0.95 \qquad Conditional Expression ( 6 )$$

$$75. < v 3 L \qquad Conditional Expression ( 7 )$$

$$0.01 < f 3 / fVR < 2. \qquad Conditional Expression ( 8 )$$

$$0.3 < ( - f 2 ) / fMt < 0.8 \qquad Conditional Expression ( 9 )$$

$$0.01 < ( - fF ) / fMt < 5. \qquad Conditional Expression ( 10 )$$

$$0.01 < fMt / \vert fRt \vert < 1. \qquad Conditional Expression ( 11 )$$

$$0.01 < ( - fF ) / \vert fRt \vert < 1. \qquad Conditional Expression ( 12 )$$

$$0.01 < fMt / ( - fFRt ) < 1. \qquad Conditional Expression ( 13 )$$

$$0.1 < β Rt / β Rw < 2. \qquad Conditional Expression ( 14 )$$

$$75. < vML \qquad Conditional Expression ( 15 )$$

$$0.01 < fMt / fVR < 1. \qquad Conditional Expression ( 16 )$$

$$0.01 < fVR / ( - fF ) < 2.5 \qquad Conditional Expression ( 17 )$$

$$0.01 < ( - f 2 ) / f 1 < 1. \qquad Conditional Expression ( 18 )$$

$$0.01 < TLt / ft < 2. \qquad Conditional Expression ( 19 )$$

$$0.01 < β Ft / β Fw < 2. \qquad Conditional Expression ( 20 )$$

$$75. < v 1 L \qquad Conditional Expression ( 21 )$$

### [Conditional Expression Corresponding Value](First to Fourth Example)

| Conditional | First | Second | Third | Fourth |
|---|---|---|---|---|
| Expression | Example | Example | Example | Example |
| (1) | 0.493 | 0.318 | 0.321 | — |
| (2) | 2.203 | 2.088 | 1.928 | — |
| (3) | 0.224 | 0.153 | 0.166 | — |
| (4) | 0.747 | 0.672 | 0.737 | — |
| (5) | 1.236 | 1.159 | 1.166 | — |
| (6) | 0.557 | 0.556 | 0.556 | 0.583 |
| (7) | 82.57 | 81.61 | 81.61 | — |
| (8) | 0.692 | 0.644 | 0.643 | — |
| (9) | 0.660 | 0.660 | 0.669 | 0.678 |
| (10) | 2.203 | 2.088 | 1.928 | 1.652 |
| (11) | 0.224 | 0.153 | 0.166 | 0.049 |
| (12) | 0.493 | 0.318 | 0.321 | 0.081 |
| (13) | 0.747 | 0.672 | 0.737 | 0.502 |
| (14) | 1.236 | 1.159 | 1.166 | 0.930 |
| (15) | 82.57 | 81.61 | 81.61 | — |
| (16) | 0.692 | 0.644 | 0.643 | 0.705 |
| (17) | 1.524 | 1.345 | 1.239 | 1.165 |
| (18) | 0.170 | 0.165 | 0.164 | 0.168 |
| (19) | 1.112 | 1.111 | 1.106 | 1.096 |
| (20) | 1.275 | 1.293 | 1.321 | 1.599 |
| (21) | 82.57 | 81.61 | 81.61 | — |

Each of the above examples can realize a zoom optical system which provides excellent optical performance while having a small size.

Each of the above examples represents one specific example of the invention of the present application, but the invention of the present application is not limited to those.

It is possible to appropriately employ the following contents in a range in which the optical performance of the zoom optical systems of the embodiments is not impaired.

Five-group configurations and a six-group configuration are described as the examples of the zoom optical systems of the embodiments; however, the present application is not limited to those, and zoom optical systems in other group configurations (for example, seven groups, eight groups, nine groups, and so forth) can be configured. For example, a configuration is possible in which a lens or a lens group is added to a side of the zoom optical system of each of the embodiments, the side being closest to the object or closest to the image surface. Further, for example, the intermediate group may include three or more lens groups, and the rear group may include two or more lens groups. Note that a lens group denotes a portion having at least one lens that is separated by an air distance which changes in zooming.

In the zoom optical system of each of the embodiments, a focusing lens group is not limited to the fourth lens group or the fifth lens group, but the focusing lens group may be formed in which a single or a plurality of lens groups or a partial lens group is moved in the optical axis direction and focusing is thereby performed from an object at infinity to a short-distance object. The focusing lens group is applicable to autofocus and is also suitable for motor driving (using an ultrasonic motor or the like) for autofocus.

In the zoom optical system of each of the embodiments, not only a part of lenses of the third lens group or a part of lenses of the fourth lens group but also a lens group or a partial lens group is moved so as to have a component in a direction perpendicular to the optical axis or is rotationally moved (swung) in an in-plane direction including the optical axis, and a vibration-proof lens group may thereby be provided which corrects an image blur caused due to camera shake.

A lens surface may be formed with a spherical surface or a flat surface or may be formed with an aspherical surface. A case where the lens surface is a spherical surface or a flat surface is preferable because processing, assembly, and adjustment of a lens become easy and degradation of optical performance due to errors in processing, assembly, and adjustment can be prevented. Further, the above case is preferable because degradation of representation performance is small even in a case where the image surface is deviated.

In a case where the lens surface is an aspherical surface, the aspherical surface may be any of an aspherical surface by a grinding process, a glass-molding aspherical surface in which glass is formed into an aspherical surface shape by a mold, and a composite type aspherical surface in which a resin is formed into an aspherical surface shape on a surface of glass. Further, the lens surface may be formed as a diffraction surface, and a lens may be formed as a gradient-index lens (GRIN lens) or a plastic lens.

It is preferable that the aperture stop be arranged between the second lens group and the third lens group, but without providing a member as the aperture stop, its function may be provided by a frame of a lens instead.

In order to reduce a flare or a ghost and to achieve optical performance with high contrast, each lens surface may be coated with an anti-reflection film which has a high transmittance in a wide wavelength range.

EXPLANATION OF NUMERALS AND CHARACTERS

| | |
|---|---|
| G1 first lens group | G2 second lens group |
| G3 third lens group | G4 fourth lens group |
| G5 fifth lens group | G6 sixth lens group |
| I image surface | S aperture stop |

1. A zoom optical system comprising:
a first lens group having positive refractive power; a second lens group having negative refractive power; a third lens group having positive refractive power; a fourth lens group having negative refractive power; and a fifth lens group having negative refractive power, which are aligned in order from an object side along an optical axis, wherein
when zooming is performed, intervals between neighboring lens groups are changed,
the fourth lens group is a focusing lens group which moves along the optical axis when focusing is performed, and
the following conditional expression is satisfied,
$$0.11 < f 4 / f 5 < 0.7$$
where f4 denotes a focal length of the fourth lens group, and
f5 denotes a focal length of the fifth lens group.

2. The zoom optical system according to claim 1, wherein the following conditional expression is satisfied,
$$0.01 < ( - f 4 ) / f 3 < 5.$$
where f3 denotes a focal length of the third lens group.

3. The zoom optical system according to claim 1 or 2, wherein the following conditional expression is satisfied,
$$0.01 < f 3 / ( - f 5 ) < 1.$$
where f3 denotes a focal length of the third lens group.

4. The zoom optical system according to any one of claims 1 to 3, wherein the following conditional expression is satisfied,
$$0.01 < f 3 / ( - f 45 t ) < 2.$$
where f3 denotes a focal length of the third lens group, and
f45t denotes a combined focal length of the fourth lens group and the fifth lens group in a telephoto end state.

5. The zoom optical system according to any one of claims 1 to 4, wherein the following conditional expression is satisfied,
$$0.01 < β5t / β5w < 2.00$$
where β5t denotes a lateral magnification of the fifth lens group in a telephoto end state, and
β5w denotes a lateral magnification of the fifth lens group in a wide angle end state.

6. The zoom optical system according to any one of claims 1 to 5, wherein the following conditional expression is satisfied,
$$0.01 < Bfw / fw < 0.95$$
where Bfw denotes a back focal length of the zoom optical system in a wide angle end state, and
fw denotes a focal length of the zoom optical system in the wide angle end state.

7. The zoom optical system according to any one of claims 1 to 6, wherein the fifth lens group consists of two lenses.

8. The zoom optical system according to any one of claims 1 to 7, wherein the third lens group has a lens which satisfies the following conditional expression,
75.00<ν3L
where ν3L denotes an Abbe number of the lens in the third lens group.

9. The zoom optical system according to any one of claims 1 to 8, wherein the third lens group has, in a part of the third lens group, a vibration proof group which is movable to have a displacement component in a direction perpendicular to the optical axis.

10. The zoom optical system according to claim 9, wherein the following conditional expression is satisfied,
$$0. 01 < f 3 / fVR < 2.00$$
where f3 denotes a focal length of the third lens group, and
fVR denotes a focal length of the vibration proof group.

11. The zoom optical system according to claim 9 or 10, wherein the vibration proof group is arranged on a side of the third lens group, the side being closest to an image surface.

12. A zoom optical system consisting of:
a first lens group having positive refractive power; a second lens group having negative refractive power; an intermediate group which has at least one lens group and which has positive refractive power; a focusing lens group having negative refractive power; and a rear group having at least one lens group, which are aligned in order from an object side along an optical axis, wherein
when zooming is performed, intervals between neighboring lens groups are changed,
the focusing lens group moves along the optical axis when focusing is performed, and
the following conditional expressions are satisfied,
$$0. 30 < ( - f 2 ) / fMt < 0 \text{.80}$$
$$0.01 < Bfw / fw < 0. 95$$
where f2 denotes a focal length of the second lens group,
fMt denotes a focal length of the intermediate group in a telephoto end state,
Bfw denotes a back focal length of the zoom optical system in a wide angle end state, and
fw denotes a focal length of the zoom optical system in the wide angle end state.

13. The zoom optical system according to claim 12, wherein the following conditional expression is satisfied,
$$0. 01 < ( - fF ) / fMt < 5.00$$
where fF denotes a focal length of the focusing lens group.

14. The zoom optical system according to claim 12 or 13, wherein the following conditional expression is satisfied,
$$0.01 < fMt / \vert fRt \vert < 1. 00$$
where fRt denotes a focal length of the rear group in the telephoto end state.

15. The zoom optical system according to any one of claims 12 to 14, wherein the following conditional expression is satisfied,
$$0.01 < ( - fF ) / \vert fRt \vert < 1. 00$$
where fF denotes a focal length of the focusing lens group, and
fRt denotes a focal length of the rear group in the telephoto end state.

16. The zoom optical system according to any one of claims 12 to 15, wherein the following conditional expression is satisfied,
$$0.01 < fMt / ( - fFRt ) < 1.$$
where fFRt denotes a combined focal length of the focusing lens group in the telephoto end state and the at least one lens group of the rear group.

17. The zoom optical system according to any one of claims 12 to 16, wherein the following conditional expression is satisfied,
$$0. 10 < β Rt / β Rw < 2.00$$
where βRt denotes a lateral magnification of the rear group in the telephoto end state, and
βRw denotes a lateral magnification of the rear group in the wide angle end state.

18. The zoom optical system according to any one of claims 12 to 17, wherein the rear group consists of two lenses.

19. The zoom optical system according to any one of claims 12 to 18, wherein the intermediate group consists of one lens group.

20. The zoom optical system according to any one of claims 12 to 19, wherein the rear group consists of one lens group.

21. The zoom optical system according to any one of claims 12 to 20, wherein the rear group has negative refractive power.

22. The zoom optical system according to any one of claims 12 to 21, wherein the intermediate group has a lens which satisfies the following conditional expression,
75.00<νML
where νML denotes an Abbe number of the lens in the intermediate group.

23. The zoom optical system according to any one of claims 12 to 22, wherein the intermediate group has, in a part of the intermediate group, a vibration proof group which is movable to have a displacement component in a direction perpendicular to the optical axis.

24. The zoom optical system according to claim 23, wherein the following conditional expression is satisfied,
$$0. 01 < fMt / fVR < 1.00$$
where fVR denotes a focal length of the vibration proof group.

25. The zoom optical system according to claim 23 or 24, wherein the vibration proof group is arranged on a side of the intermediate group, the side being closest to an image surface.

26. The zoom optical system according to any one of claims 9 to 11 and claims 23 to 25, wherein the following conditional expression is satisfied,
$$0. 01 < fVR / ( - fF ) < 2.50$$
where fVR denotes a focal length of the vibration proof group, and
fF denotes a focal length of the focusing lens group.

27. The zoom optical system according to any one of claims 9 to 11 and claims 23 to 26, wherein the vibration proof group consists of two lenses.

28. The zoom optical system according to any one of claims 1 to 27, wherein the following conditional expression is satisfied,
$$0. 01 < ( - f 2 ) / f 1 < 1. 00$$
where f1 denotes a focal length of the first lens group, and
f2 denotes a focal length of the second lens group.

29. The zoom optical system according to any one of claims 1 to 28, wherein the following conditional expression is satisfied,
$$0. 01 < TLt / ft < 2.$$
where TLt denotes an entire length of the zoom optical system in a telephoto end state, and
ft denotes a focal length of the zoom optical system in the telephoto end state.

30. The zoom optical system according to any one of claims 1 to 29, wherein the following conditional expression is satisfied,
$$0.01 < β Ft / β Fw < 2.00$$
where βFt denotes a lateral magnification of the focusing lens group in a telephoto end state, and
βFw denotes a lateral magnification of the focusing lens group in a wide angle end state.

31. The zoom optical system according to any one of claims 1 to 30, wherein the focusing lens group consists of two lenses.

32. The zoom optical system according to any one of claims 1 to 31, wherein the first lens group has a lens which satisfies the following conditional expression,
75.00<ν1L
where ν1L denotes an Abbe number of the lens in the first lens group.

33. An optical apparatus which includes the zoom optical system according to any one of claims 1 to 32.

34. A method for manufacturing a zoom optical system comprising a first lens group having positive refractive power, a second lens group having negative refractive power, a third lens group having positive refractive power; a fourth lens group having negative refractive power; and a fifth lens group having negative refractive power, which are aligned in order from an object side along an optical axis, comprises;
arranging the lens groups in a lens barrel so that:
when zooming is performed, intervals between neighboring lens groups are changed,
the fourth lens group is a focusing lens group which moves along the optical axis when focusing is performed, and
the following conditional expression is satisfied,
$$0. 11 < f 4 / f 5 < 0.70$$
where f4 denotes a focal length of the fourth lens group, and
f5 denotes a focal length of the fifth lens group.
